(19) United States
(12) Patent Application Publication
(10) Pub. No.: US 2012/0069055 A1
(43) Pub. Date: Mar. 22, 2012

(54) IMAGE DISPLAY APPARATUS

(75) Inventors: Masaki OTSUKI, Yokohama-shi (JP); Hidenori Kuribayashi, Tokyo (JP)

(73) Assignee: NIKON CORPORATION, TOKYO (JP)

(21) Appl. No.: 13/238,395

(22) Filed: Sep. 21, 2011

(30) Foreign Application Priority Data
Sep. 22, 2010 (JP) 2010-212001
Sep. 22, 2010 (JP) 2010-212002
Jul. 7, 2011 (JP) 2011-150734
Aug. 30, 2011 (JP) 2011-187401
Aug. 30, 2011 (JP) 2011-187402

(51) Int. Cl. G09G 5/00

(52) U.S. Cl. 345/681

(57) ABSTRACT

An image display apparatus includes a detection unit that detects a target object, and a display control unit that adjusts an image display method through which an image is displayed, so as to alter the image as visually perceived along a direction of visually perceived depth when the detection unit detects the target object.

### CROSS-REFERENCES TO RELATED APPLICATIONS

The present application claims priority under 35 U.S.C. §119 to Japanese Patent Application No. 2010-212001, filed Sep. 22, 2010; Japanese Patent Application No. 2010-212002, filed Sep. 22, 2010; Japanese Patent Application No. 2011-150734, filed Jul. 7, 2011; Japanese Patent Application No. 2011-187401, filed Aug. 30, 2011, and Japanese Patent Application No. 2011-187402, filed Aug. 30, 2011. The contents of these applications are incorporated herein by reference in their entirety.

### BACKGROUND OF THE INVENTION

1. Field of the Invention

The present invention relates to an image display apparatus.

2. Description of Related Art

Japanese Laid Open Patent Publication No. 2010-81466 discloses an operation control device. This operation control device allows an image to be manipulated in response to a user's hand movement.

### SUMMARY OF THE INVENTION

An image display apparatus achieved in an aspect of the present invention comprises a detection unit and a display control unit. The detection unit detects a target object. When the detection unit detects the target object, the display control unit adjusts an image display method through which an image is displayed so as to alter the image along a direction of visually perceived depth along which depth is visually perceived.

An image display apparatus achieved in another aspect of the present invention comprises a detection unit and a display control unit. The detection unit detects a target object. When the detection unit detects the target object, the display control unit brings up an image in a display having a three-dimensional effect.

An image display apparatus achieved in yet another aspect of the present invention comprises a display unit, a detection unit, a specific area determining unit and a display control unit. The display unit displays a plurality of display images manifesting parallaxes different from one another toward a viewpoint that corresponds to the particular display image among a plurality of display images. The detection unit detects an object present to the front of the display unit. The specific area determining unit determines, based upon detection results provided by the detection unit, a specific area of the display screen at the display unit that is blocked by the object when observed by a viewer. The display control unit executes display control so as to display a portion of an image displayed at the display unit, which is contained in an area around the specific area having been determined, by adopting a display mode different from a display mode for the remaining area.

### BRIEF DESCRIPTION OF THE DRAWINGS

A more complete appreciation of the invention and the many attendant advantages thereof will be readily obtained as the same becomes better understood by reference to the following detailed description when considered in connection with the accompanying drawings.

FIG. 1 is a block diagram showing the structure of an image display apparatus achieved in a first embodiment.

FIG. 2 is a schematic illustration providing an external view of a digital photo frame.

FIG. 3 presents a flowchart of the image reproduction state adjustment processing.

FIGS. 4A, 4B and 4C show how a given reproduced image on display may be presented stereoscopically to the viewer's eye by adding an image shadow.

FIGS. 5A, 5B and 5C show how a given reproduced image on display may be rendered so as to appear to sink into a perspective effect in the background area present around the reproduced image.

FIG. 6 provides a first illustration showing how the currently reproduced image may be switched to another in response to a user's hand movement.

FIG. 7 provides a second illustration showing how the currently reproduced image may be switched to another in response to a user's hand movement.

FIGS. 8A and 8B present a specific example in which the image size is altered in a second embodiment.

FIGS. 9A and 9B present a specific example in which the image contrast is altered in the second embodiment.

FIGS. 10A, 10B and 10C present a specific example in which the image shape is altered in the second embodiment.

FIGS. 11A, 11B and 11C present a specific example in which the image or the background area is smoothed in the second embodiment.

FIGS. 12A and 12B present a specific example in which the position of the viewpoint, relative to the image, is altered in the second embodiment.

FIGS. 13A, 13B, 13C and 13D present a specific example in which the shapes of the image and the background area are altered in a third embodiment.

FIGS. 14A, 14B and 14C illustrate a method adopted to achieve a stereoscopic effect to the display of an image in a fourth embodiment.

FIG. 15 presents a specific example in which the size of the shadow at an image is adjusted in the fourth embodiment.

FIG. 16 presents a specific example in which perspective is applied to an image in the fourth embodiment.

FIG. 17 presents a specific example in which the image contrast is altered in the fourth embodiment.

FIG. 18 presents a specific example in which the image size is altered in the fourth embodiment.

FIG. 19 presents a specific example in which the extent to which the image is smoothed is altered in the fourth embodiment.

FIG. 20 presents a specific example in which the position of the viewpoint, relative to the image, is altered in the fourth embodiment.

FIGS. 21A through 21E illustrate the image reproduction state adjustment processing executed in a fifth embodiment.

FIGS. 22A and 22B present a specific example in which perspective is applied to an image in a sixth embodiment.

FIGS. 23A and 23B present a specific example in which the position of the viewpoint, relative to the image, is altered in the sixth embodiment.

FIG. 24 is a block diagram showing the structure of an image display apparatus achieved in a seventh embodiment.

FIG. 25 is a schematic illustration providing an external view of a digital photo frame.

FIG. 26 presents a flowchart of image reproduction state adjustment processing.

FIGS. 27A, 27B and 27C provide a first illustration of a specific example in which a reproduced image is displayed with a 3-D effect.

FIGS. 28A, 28B and 28C provide a second illustration of a specific example in which a reproduced image is displayed with a 3-D effect.

FIGS. 29A and 29B present a specific example in which an image is displayed with a 3-D effect in an eighth embodiment.

FIGS. 30A, 30B and 30C present a specific example in which an image is displayed with a 3-D effect in a ninth embodiment.

FIG. 31 presents a specific example in which an image is displayed with a 3-D effect in the ninth embodiment.

FIGS. 32A through 32D present a specific example in which an image is displayed with a 3-D effect in a tenth embodiment.

FIGS. 33A through 33E present a specific example in which an image is displayed with a 3-D effect in an eleventh embodiment.

FIGS. 34A through 34D present a specific example in which images are displayed with a 3-D effect in a variation (12).

FIG. 35 presents an external view of a digital photo frame.

FIG. 36 presents a flowchart of the display control processing executed by the control device.

FIG. 37 presents an example of a reproduced image on display at the monitor.

FIG. 38 shows a reproduced image currently on display at the monitor with a hand held in front of the monitor.

FIG. 39 illustrates surrounding areas.

FIG. 40 illustrates the surrounding area assumed in the second embodiment.

FIG. 41 illustrates how the parallax may be altered.

### DESCRIPTION OF EMBODIMENTS

An image display apparatus achieved in a mode of the present invention comprises a detection unit that detects a target object and a display control unit that adjusts an image display method through which an image is displayed, so as to alter the image as visually perceived along a front-back direction when the detection unit detects the target object.

It is desirable that the display control unit in the image display apparatus alters the image continuously.

It is desirable that the image display apparatus further comprise a movement detection unit that detects movement of the target object and an operation unit that manipulates the image in correspondence to the movement of the target object when the movement detection unit detects movement of the target object.

It is desirable that the detection unit in the image display apparatus detects a position assumed by the target object.

It is desirable that the display control unit in the image display apparatus alters the image along a direction of visually perceived depth by adding an image shadow effect.

It is desirable that the display control unit in the image display apparatus alters the image along a direction of visually perceived depth by rendering the image so as to appear to sink into a perspective effect in the background area present around the image.

It is desirable that the display control unit in the image display apparatus switches to a first method whereby the image is altered along a direction of visually perceived depth by adding an image shadow effect or to a second method whereby the image is altered along the direction of visually perceived depth by rendering the image so as to appear to sink into a perspective effect in the background area present around the image.

It is desirable that the display control unit in the image display apparatus switches to the first method or to the second method in correspondence to the image or in correspondence to a direction in which the target object moves.

It is desirable that the target object detected by the image display apparatus be a person's hand.

It is desirable that the display control unit in the image display apparatus alters the image along a direction of visually perceived depth by altering at least one of an image size, an image contrast, an image shape, an image smoothed, an image viewpoint position and an image color.

It is desirable that the display control unit in the image display apparatus adjusts the image display method so as to alter a background area set around the image, as visually perceived front-back direction as well the image when the detection unit detects the target object.

It is desirable that the operation unit in the image display apparatus moves the image along the background area in correspondence to a movement of the target object when the image and the background area have been altered by the display control unit.

It is desirable that the operation unit in the image display apparatus moves the image while altering a perceived distance to the image along a direction of visually perceived depth in correspondence to the movement of the target object.

It is desirable that the operation unit in the image display apparatus alters the perceived distance to the image along the direction of visually perceived depth by altering at least one of; a size of the shadow added to the image, the image size, the image contrast, the image shape, and the extent to which the image is smoothed, the image viewpoint position and the image color, in correspondence to the movement of the target object.

It is desirable that the operation unit in the image display apparatus further alters the image along a direction of visually perceived depth by bringing up a reduced display of a plurality of images including the image if the movement detection unit detects movement of the target object toward the display unit when the image has been altered by the display control unit.

It is desirable that the display control unit in the image display apparatus displays a cursor used to select an image in the reduced display and that the operation unit in the image display apparatus move the cursor in correspondence to an upward movement, a downward movement, a leftward movement or a rightward movement of the target object detected by the movement detection unit while the reduced display is up.

It is desirable that the operation unit in the image display apparatus brings up the image selected with the cursor in an enlarged display if a movement of the target object moving further away from the display unit is detected by the movement detection unit while the reduced display is up.

It is desirable that the operation unit in the image display apparatus switches the image to another image or move the viewpoint taken for the image in correspondence to a rotation of the target object detected by the movement detection unit.

An image display apparatus achieved in another mode of the present invention comprises a detection unit that detects a target object and a display control unit that displays an image with a three-dimensional effect when the detection unit detects the target object.

It is desirable that the detection unit in the display apparatus detects a position assumed by the target object.

It is desirable that the image display apparatus further comprises a movement detection unit that detects movement of the target object and that the display control unit alters a perceived distance between the target object and the image along the front-back direction in correspondence to movement of the target object when the movement detection unit detects movement of the target object.

It is desirable that the display control unit in the image display apparatus alters the image so that the distance between the target object and the image along the front-back direction is visually perceived to be constant at all times.

It is desirable that the display control unit in the image display apparatus brings up an image display with a three-dimensional effect so that the image appears to jump forward by shortening the visually perceived distance between the target object and the image along the front-back direction.

It is desirable that the display control unit in the image display apparatus renders the image so that the image appears to jump to a position close to the target object.

It is desirable that the display control unit in the image display apparatus achieve a three-dimensional effect for the display of the image so that the image appears to sink inward by increasing the visually perceived distance between the target object and the image along the front-back direction.

It is desirable that the display control unit in the image display apparatus switches to a first method whereby a three-dimensional effect is achieved for the display of the image so that the image appears to jump forward by shortening the visually perceived distance between the target image and the image along the front-back direction or to a second method whereby a three-dimensional effect is achieved for the display of the image so that the image appears to sink inward by increasing the visually perceived distance between the target object and the image along the front-back direction.

It is desirable that the display control unit in the image display apparatus switches to the first method or to the second method in correspondence to the image or in correspondence to the direction in which the target object moves.

It is desirable that the target object detected by the image display apparatus be a person's hand.

It is desirable that the display control unit in the image display apparatus achieve a three-dimensional effect in the display of the image by altering the shape of the image and also by rendering a visually perceived depth corresponding to the shape when the detection unit detects the target object.

It is desirable that the display control unit in the image display apparatus moves the image while altering the distance between the target object and the image along the front-back direction in correspondence to the movement of the target object.

It is desirable that the image display apparatus further comprises a processing execution unit that executes processing designated in correspondence to the image when the movement detection unit detects that the target object has moved toward a display unit until a distance between the target object and the display unit has become equal to or less than a predetermined value.

It is desirable that the display control unit in the image display apparatus reduces a plurality of images including the image and achieve a three-dimensional effect in the display of the images when the movement detection unit detects a movement of the target object toward the display unit.

An image display apparatus achieved in another mode of the present invention comprises a display unit at which at least two images manifesting parallaxes different from one another in correspondence to a plurality of viewpoints are displayed, a detection unit that detects an object present in front of the display unit, a specific area determining unit that determines, based upon detection results provided by the detection unit, a specific area of the display screen at the display unit that is blocked by the object when observed by the viewer and a display control unit that executes display control so as to display a portion of an image displayed at the display unit, which is contained in an area around the specific area having been determined, by adopting a display mode different from a display mode for the remaining area.

It is desirable that the display control unit in the image display apparatus alters the display mode by altering at least one of; the brightness, the color and the contrast of the display image.

It is desirable that the display control unit in the image display apparatus alters the display mode by changing the parallax manifested in correspondence to the display image.

It is desirable that the detection unit in the image display apparatus detects the object based upon an image signal output from an image sensor.

It is desirable that the image display apparatus further comprises an operation control unit that accepts an operation corresponding to a movement of the object detected by the detection unit.

It is desirable that the object detected by the image display apparatus be a person's hand.

The embodiments will now be described with reference to the accompanying drawings, wherein the same reference numerals designate identical elements throughout the various drawings.

### First Embodiment

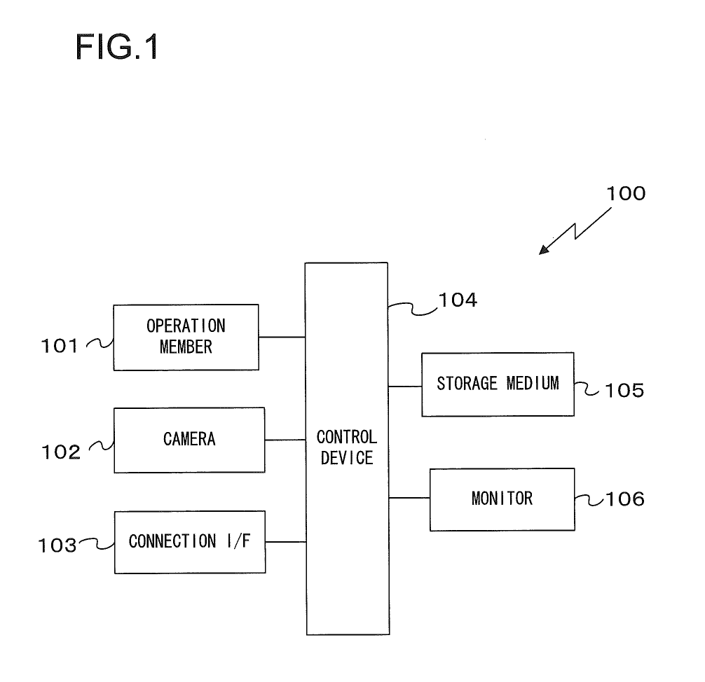

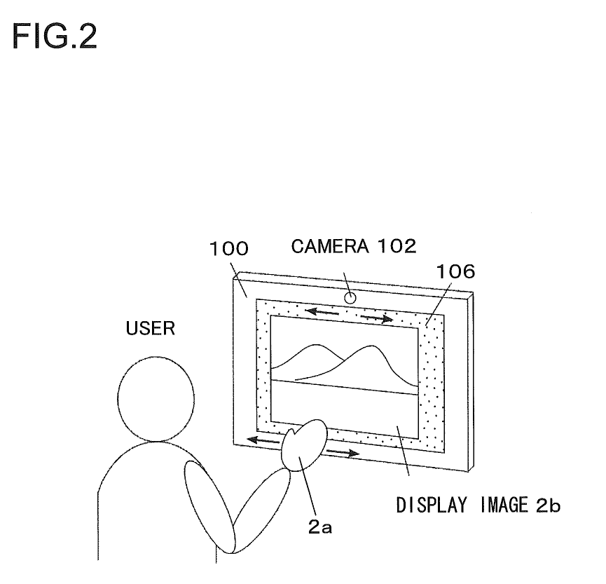

FIG. 1 is a block diagram showing the structure of the image display apparatus achieved in the first embodiment. The image display apparatus may be embodied as, for instance, a digital photo frame 100 such as that shown in FIG. 2. The digital photo frame 100 comprises an operation member 101, a camera 102, a connection I/F (interface) 103, a control device 104, a storage medium 105, and a monitor 106.

The operation member 101 includes various devices, such as operation buttons, operated by the user of the digital photo frame 100. As an alternative, a touch panel may be mounted at the monitor 106 so as to enable the user to operate the digital photo frame via the touch panel.

The camera 102 is equipped with an image sensor such as a CCD image sensor or a CMOS image sensor. With the camera 102, which is disposed at the front surface of the digital photo frame 100, as shown in FIG. 2, the user facing the digital photo frame 100 can be photographed. Image signals output from the image sensor in the camera 102 are output to the control device 104, which then generates image data based upon the image signals.

The connection I/F 103 is an interface via which the digital photo frame 100 establishes a connection with an external device. The digital photo frame 100 in the embodiment is connected with an external device with image data recorded therein, such as a digital camera, via the connection I/F 103. The control device 104 takes in image data from the external device via the connection I/F 103 and records the image data thus taken in into the storage medium 105. It is to be noted that the connection I/F 103 may be a USB interface via which a wired connection between the external device and the digital photo frame 100 is established, a wireless LAN module via which the external device and the digital photo frame 100 can be connected with each other wirelessly, or the like. As an alternative, the image display apparatus may include a memory card slot instead of the connection I/F 103, and in such a case, image data can be taken into the image display apparatus as a memory card with image data recorded therein is loaded in the memory card slot.

The control device 104, constituted with a CPU, a memory and other peripheral circuits, executes overall control for the digital photo frame 100. It is to be noted that the memory constituting part of the control device 104 is a volatile memory such as an SDRAM. This memory includes a work memory where a program is opened when the CPU executes the program and a buffer memory where data are temporarily recorded.

In the storage medium 105, which is a nonvolatile memory such as a flash memory, a program executed by the control device 104, image data having been taken in via the connection I/F 103, and the like are recorded. At the monitor 106, which may be, for instance, a liquid crystal monitor, a reproduction target image 2b is displayed as shown in FIG. 2.

The control device 104 in the digital photo frame 100 achieved in the embodiment detects a movement of a user's hand 2a based upon an image captured by the camera 102 and adjusts the reproduction state of the image 2b in correspondence to the movement of the hand 2a. In other words, the user of the digital photo frame 100 achieved in the embodiment is able to manipulate the reproduced image 2b currently on display by moving his hand 2a. The following is a description of the reproduction state adjustment processing executed by the control device 104 to adjust the reproduction state of the image 2b in correspondence to the movement of the user's hand 2a.

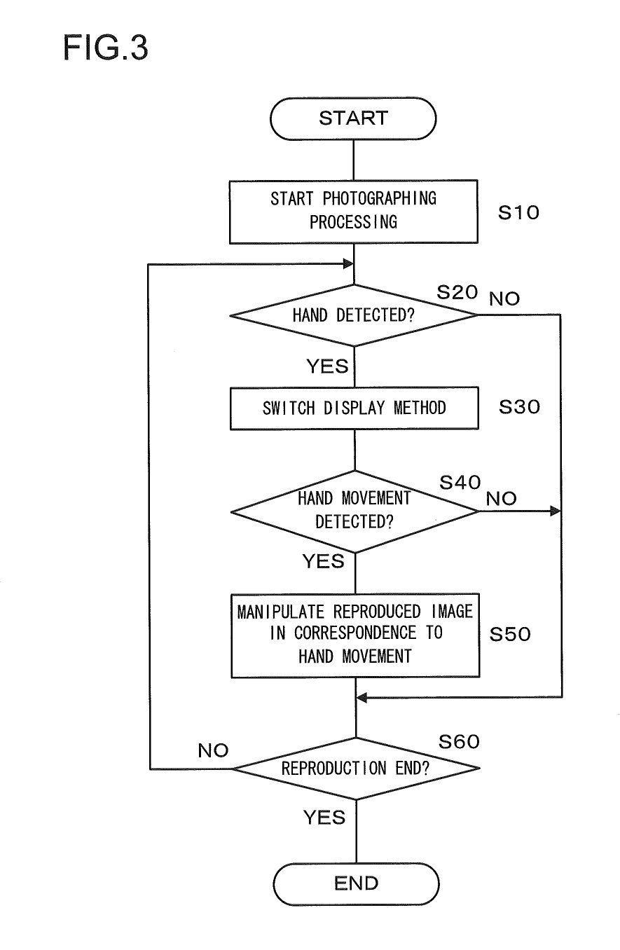

FIG. 3 presents a flowchart of the reproduction state adjustment processing executed to adjust the reproduction state of the image 2b in correspondence to a movement of the user's hand 2a. The processing shown in FIG. 3 is executed by the control device 104 as a program that is started up when reproduction of the image 2b at the monitor 106 starts.

In step S10, the control device 104 starts photographing images via the camera 102. The camera 102 in the embodiment is engaged in photographing operation at a predetermined frame rate and thus, image data are successively input to the control device from the camera 102 over predetermined time intervals corresponding to the frame rate. Subsequently, the operation proceeds to step S20.

In step S20, the control device 104 makes a decision, based upon the image data input from the camera 102, as to whether or not the user's hand 2a is included in the input image. For instance, an image of the user's hand 2a may be recorded in advance as a template image, and, in such a case, the control device 104 is able to decide whether or not the user's hand 2a is included in the input image by comparing the input image to the template image through matching processing. If a negative decision is made in step S20, the operation proceeds to step S60 to be described later. However, if an affirmative decision is made in step S20, the operation proceeds to step S30.

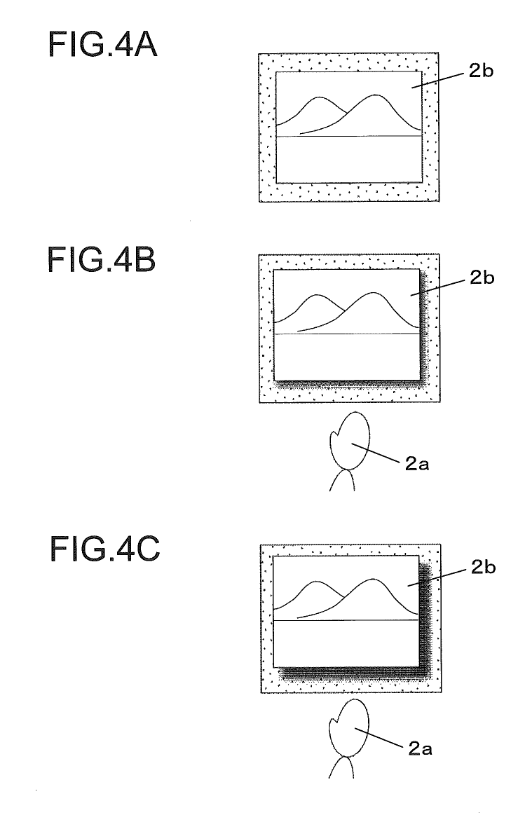

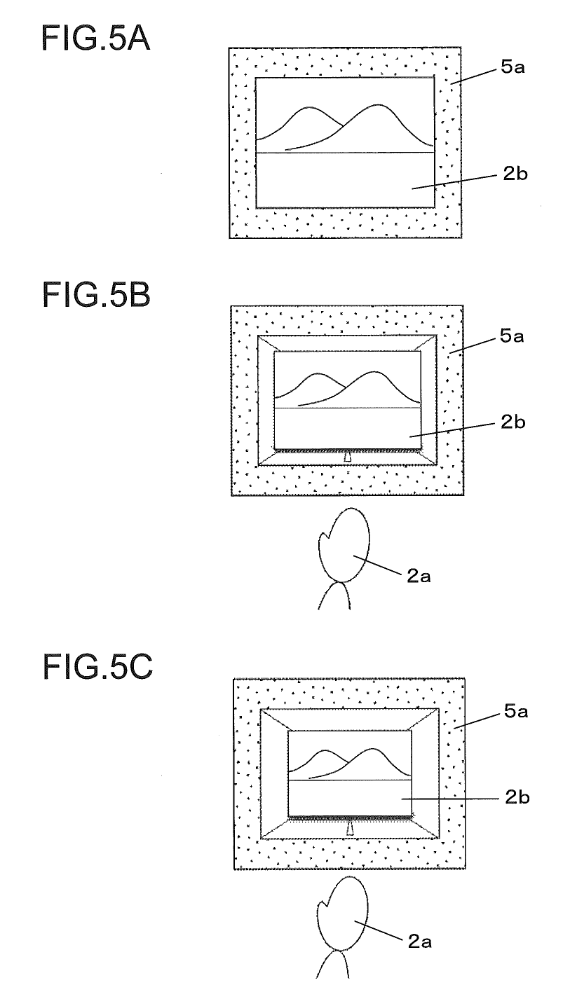

Based upon the decision made in step S20 that the user's hand 2a has been detected, the control device 104 adjusts the reproduction method for reproducing the image 2b in step S30 so as to alter the reproduced image 2b along a direction of visually perceived depth (along the front-back direction). Methods that may be adopted when adjusting the reproduction method for the image 2b upon detecting the user's hand 2a are now described. At the digital photo frame 100 achieved in the embodiment, at which the image 2b is displayed at the monitor 106 by adopting a standard reproduction method under normal circumstances, the reproduction method can be switched to a first reproduction method whereby the reproduced image 2b is displayed stereoscopically by adding a shadow to the reproduced image 2b, as illustrated in FIGS. 4A, 4B and 4C, or to a second reproduction method whereby the reproduced image 2b is made to appear to sink into a perspective effect rendered in a background area 5a set around the image, as illustrated in FIGS. 5A, 5B and 5C.

The control device 104 in the embodiment adjusts the reproduction method for the image 2b by switching from the standard reproduction method to the first reproduction method or to the second reproduction method upon detecting the user's hand 2a. It is to be noted that a setting, indicating a specific reproduction method, i.e., either the first reproduction method or the second reproduction method, to be switched to upon detecting the user's hand 2a, is selected in advance. In addition, the processing that needs to be executed to display the reproduced image 2b in stereoscopically by adding a shadow to the image 2b and the processing that needs to be executed so as to make the reproduced image 2b appear as if the image 2b is sinking into the perspective effect in the background area 5a set around the image are of the known art in the field of 3-D CG (three-dimensional computer graphics) technologies and the like, and accordingly, a special explanation of such processing is not provided here.

In the first method illustrated in FIGS. 4A, 4B and 4C, the control device 104, having detected the user's hand 2a while reproducing the image 2b through the standard reproduction method, as shown in FIG. 4A, achieves a stereoscopic effect in the display of the reproduced image 2b by adding a shadow to the reproduced image 2b, as shown in FIG. 4B. As a result, the user experiences a sensation of the image 2b being pulled toward his hand held in front of the monitor 106.

In addition, in the second method illustrated in FIGS. 5A, 5B and 5C, the control device 104, having detected the user's hand 2a while reproducing the image 2b through the standard reproduction method, as shown in FIG. 5A, makes the reproduced image 2b appear to sink into the perspective effect rendered in the background area 5a set around the image, as shown in FIG. 5B. As a result, the user experiences a sensation of the hand, held in front of the monitor 106, pushing the image 2a deeper into the screen.

Subsequently, the operation proceeds to step S40, in which the control device 104 makes a decision as to whether or not the position of the user's hand 2a has changed within the image, i.e., whether or not a movement of the user's hand 2a has been detected, by monitoring for any change in the position of the hand 2a, occurring from one set of image data to another set of image data among sets of image data input in time series from the camera 102. If a negative decision is made in step S40, the operation proceeds to step S60 to be described later. If, on the other hand, an affirmative decision is made in step S40, the operation proceeds to step S50.

In step S50, the control device 104 manipulates the reproduced image 2b currently on display in correspondence to the movement of the user's hand 2a having been detected in step S40. A movement of the hand 2a may be detected while the image 2b reproduced through the first method described earlier currently on display, as shown in FIG. 4B, the manipulation of the image 2b in this instance is first described. In this situation, upon detecting that the area taken up by the user's hand 2a has become greater within an image input from the camera 102, i.e., upon detecting that the user's hand 2a has moved closer to the monitor 106, the control device 104 makes the reproduced image 2b appear to lifted further forward by increasing the size of the shadow of the image 2b, as shown in FIG. 4C. As a result, the user, having moved his hand closer to the monitor 106, experiences a sensation of the image 2b being pulled toward the hand.

If, on the other hand, the control device 104 detects that the area taken up by the user's hand 2a has become smaller within an image input from the camera 102, i.e., if the control device 104 detects that the user's hand 2a has moved further away from the monitor 106, the control device 104 reduces the size of the shadow of the image 2b, causing the image to appear to be lifted forward to a lesser extent. As a result, the user, having moved his hand further away from the monitor 106, experiences a sensation of the image 2b moving away from his hand. It is to be noted that a maximum and a minimum size of the shadow to be added to the image 2b should be set in advance and that the control device 104 should adjust the size of the shadow of the image 2b within the range defined by the maximum and minimum shadow sizes.

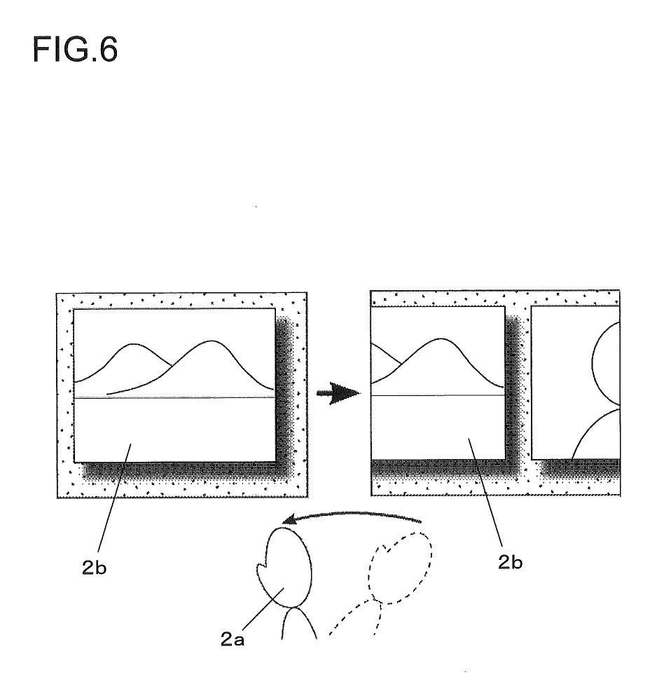

In addition, upon detecting that the user's hand 2a has moved sideways, the control device 104 switches the reproduced image 2b to another image in correspondence to the movement of the user's hand 2a, as illustrated in FIG. 6. For instance, upon detecting that the user's hand 2a has moved to the left, the control device 104 slides the reproduced image 2b to the left and displays the image preceding the image 2b by sliding the preceding image to the left. If, on the other hand, the control device 104 detects that the user's hand 2a has moved to the right, it slides the reproduced image 2b to the right and displays the image following the image 2b by sliding the following image to the right. Thus, the user is able to issue a display image switching instruction in an intuitive manner with a simple gesture of his hand.

Next, the image manipulation following detection of a movement of the hand 2a while the image 2b reproduced through the second method is currently on display, as shown in FIG. 5B, is described. In this situation, the control device 104 having detected, for instance, that the area taken up by the user's hand 2a has become greater within an image input from the camera 102, i.e., having detected that the user's hand 2a has moved closer to the monitor 106, makes the reproduced image 2b appear to sink even deeper, as illustrated in FIG. 5C. As a result, the user, having moved his hand closer to the monitor 106, experiences a sensation of the image 2b being pushed even deeper into the screen.

If, on the other hand, the control device 104 detects that the area taken up by the user's hand 2a has become smaller within an image input from the camera 102, i.e., if the control device 104 detects that the user's hand 2a has moved further away from the monitor 106, the control device 104 makes the reproduced image 2b appear as if the extent to which the image 2b sinks inward has been reduced. As a result, the user having moved his hand further away from the monitor 106 experiences a sensation of the image 2b sinking to a lesser extent. It is to be noted that a maximum extent and a minimum extent to which the image 2b is made to appear to be sinking should be set in advance and that the control device 104 should adjust the extent of sinking within the range defined by the maximum extent and the minimum extent.

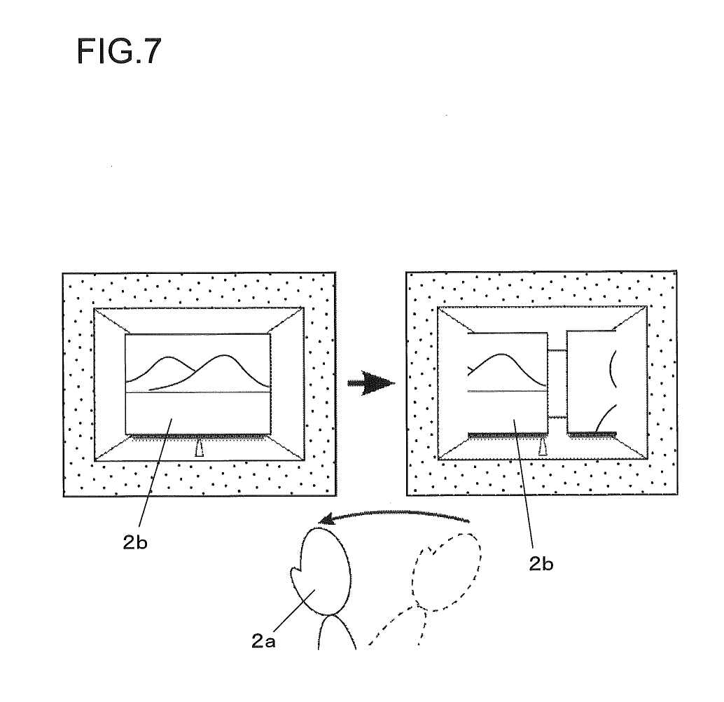

In addition, upon detecting that the user's hand 2a has moved sideways, the control device 104 switches the reproduced image 2b to another image in correspondence to the movement of the user's hand 2a, as illustrated in FIG. 7. For instance, upon detecting that the user's hand 2a has moved to the left, the control device 104 slides the reproduced image 2b to the left and displays the image preceding the image 2b by sliding the preceding image to the left. If, on the other hand, the control device 104 detects that the user's hand 2a has moved to the right, it slides the reproduced image 2b to the right and displays the image following the image 2b by sliding the following image to the right. Thus, the user is able to issue a display image switching instruction in an intuitive manner with a simple gesture of his hand. In addition, since the reproduced image 2b currently on display or the preceding/following image emerges or disappears through a side of the perspective, the display images can be switched while retaining the sinking visual effect.

Subsequently, the operation proceeds to step S60, in which the control device 104 makes a decision as to whether or not the user has issued an instruction for ending the image reproduction. If a negative decision is made in step S60, the operation returns to step S20. However, if an affirmative decision is made in step S60, the processing ends.

The following advantages are achieved through the first embodiment described above.

(1) Upon detecting the user's hand 2a in an image input from the camera 102, the control device 104 alters the reproduced image 2b currently on display along the direction of visually perceived depth, in which the depth of the image is visually perceived. As a result, the user, holding his hand in front of the monitor 106, is able to experience a sensation of the image 2b being pulled toward the user's hand or a sensation of pushing the image 2b toward the screen. In addition, the control device 104 informs the user of the detection of the target object by altering the image along the direction of visually perceived depth, without compromising the viewability of the image.

(2) The control device 104 detects a movement of the user's hand 2a and manipulates the reproduced image 2b currently on display in correspondence to the detected movement of the hand 2a. This means that the user is able to issue instructions for manipulating the image 2b in an intuitive manner with a simple gesture of his hand.

(3) The control device 104 detects the user's hand 2a captured in an input image by comparing the input image with a template image through matching processing. Thus, the user's hand 2a can be detected in the input image with a high degree of accuracy.

(4) The control device 104 alters the reproduced image 2b along the direction of visually perceived depth by adding a shadow to the reproduced image 2b. As a result, the image 2b can be rendered to achieve a stereoscopic appearance, as perceived by the user experiencing a sensation of the image 2b being lifted forward toward the user.

(5) The control device 104 makes the reproduced image 2b appear to sink inward along the perspective effect in the background area 5a set around the image. As a result, the image 2b can be rendered to achieve a stereoscopic appearance, as perceived by the user experiencing a sensation of the image 2b recede inward.

### Second Embodiment

In reference to drawings, the second embodiment of the present invention is described. The second embodiment is distinguishable from the first embodiment in the reproduction state adjustment processing executed for the image 2b and accordingly, the following detailed explanation focuses on the feature differentiating the second embodiment from the first embodiment. It is to be noted that features of the second embodiment other than the reproduction state adjustment processing executed for the image 2b are similar to those in the first embodiment and a repeated explanation thereof is not provided.

Upon detecting the user's hand 2a, the control device 104 achieved in the second embodiment adjusts the reproduction method for reproducing the image 2b so as to alter the reproduced image 2b currently on display along the direction of visually perceived depth (along the front-back direction).

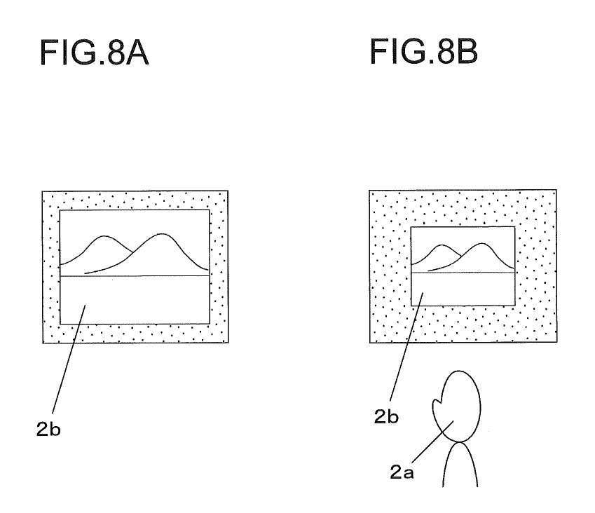

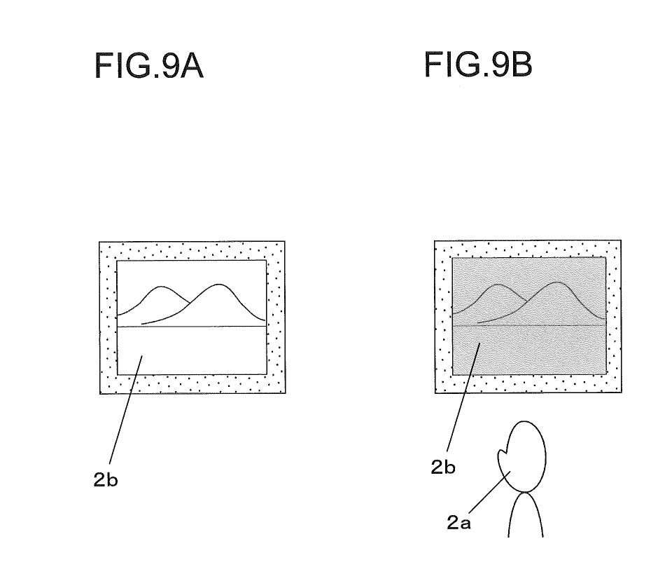

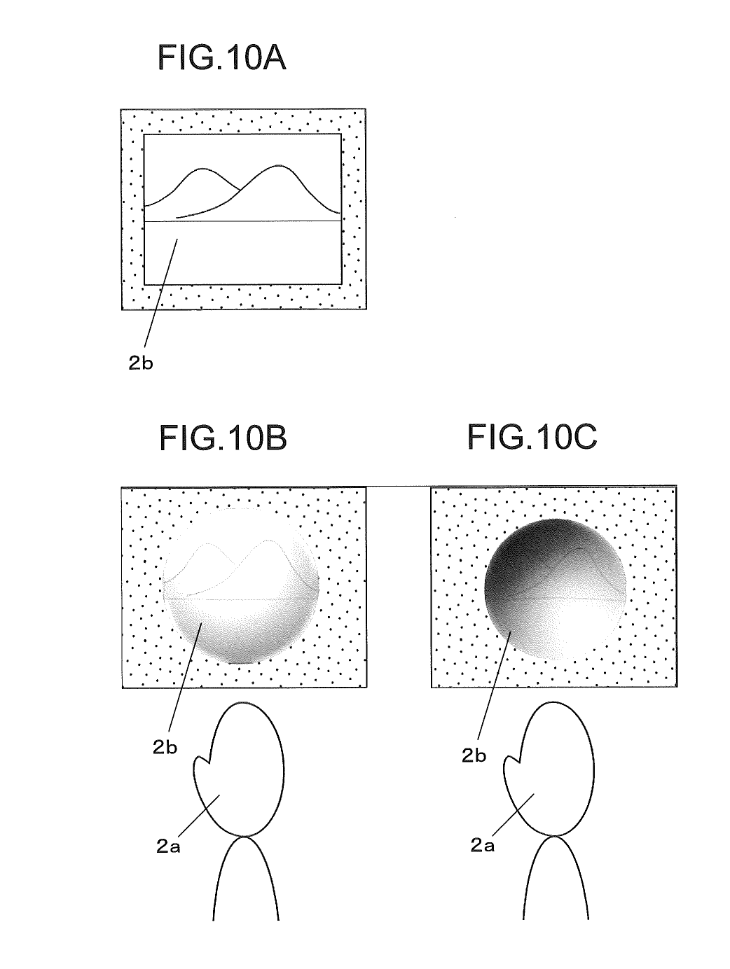

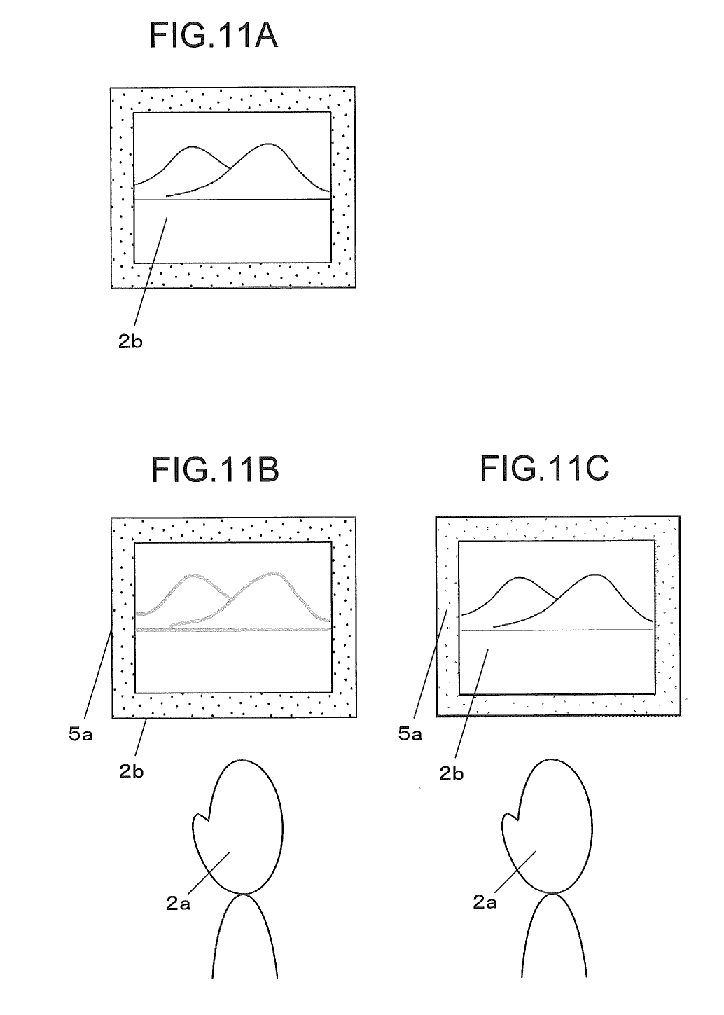

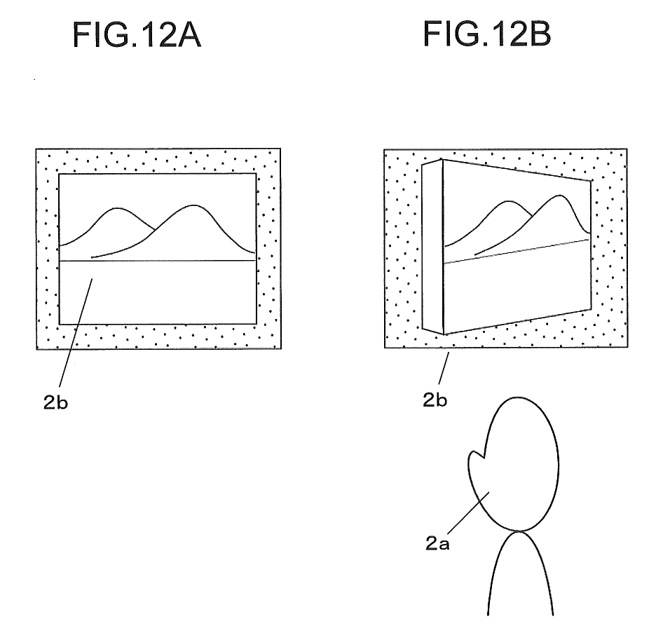

In the second embodiment, the standard reproduction method through which the image 2b is displayed at the monitor 106 can normally be switched to a third reproduction method (see FIGS. 8A and 8B) through which the size of the image 2b is altered, a fourth reproduction method (see FIGS. 9A and 9B) through which the contrast of the image 2b is altered, a fifth reproduction method (see FIGS. 10A, 10B and 10C) through which the shape of the image 2b is altered, a sixth reproduction method (see FIGS. 11A, 11B and 11C) through which the image 2b is smoothed, a seventh reproduction method (see FIGS. 12A and 12B) through which the viewpoint taken relative to the image 2b is altered or an eighth reproduction method through which the color of the image 2b is altered.

The control device 104 in the second embodiment adjusts the reproduction method for the image 2b by switching from the standard reproduction method to one of the third through eighth reproduction methods upon detecting the hand 2a. It is to be noted that a setting indicating a specific reproduction method, i.e., one of the third through eighth reproduction methods to be switched to upon detecting the hand 2a, is selected in advance.

Upon switching from the standard reproduction method shown in FIG. 8A to the third reproduction method, the control device 104 makes the image 2b appear to sink deeper into the screen by gradually reducing the size of the image 2b, as shown in FIG. 8B. The control device 104 adopting the third reproduction method may make the image 2b appear to lift off the screen by gradually enlarging the image 2b initially displayed through the standard reproduction method, instead.

Upon switching from the standard reproduction method shown in FIG. 9A to the fourth reproduction method, the control device 104 makes the image 2b appear to sink deeper into the screen by gradually lowering the contrast of the image 2b, as shown in FIG. 9B. The control device 104 adopting the fourth reproduction method may make the image 2b appear to lift off the screen by gradually raising the contrast of the image 2b initially displayed through the standard reproduction method, instead.

The control device 104 switching from the standard reproduction method shown in FIG. 10A to the fifth reproduction method makes the image 2b appear to swell up from the screen in a spherical form by gradually altering the shape of the image 2b into a spherical shape, as shown in FIG. 10B, and also by adding shading to the lower portion of the image 2b.

The control device 104 adopting the fifth reproduction method may make the image 2b, rendered into a spherical form, appear to be sunken into the screen by gradually altering the shape of the image 2b into a spherical shape and adding shading to an upper portion of the image 2b, as shown in FIG. 10C.

It is to be noted that the image reproduced through the fifth reproduction method can be perceived by the user to swell into a convex shape or to sink into a concave shape by adding shading as described earlier based upon the rule of thumb whereby a given object is normally assumed to be illuminated from directly above.

Upon switching from the standard reproduction method shown in FIG. 11A to the sixth reproduction method, the control device 104 makes the image 2b appear to sink deeper into the screen by gradually smoothing the image 2b, as shown in FIG. 11B. It is to be noted that the control device 104 adopting the sixth reproduction method may smooth the outline of the image 2b. As an alternative, the control device 104 adopting the sixth reproduction method may make the image 2b appear to lift off the screen by gradually smoothing the background area 5a instead of the image 2b, as shown in FIG. 11C.

The control device 104, having switched from the standard reproduction method shown in FIG. 12A to the seventh reproduction method, allows the image 2b to take on a stereoscopic appearance, lifted up from the screen by gradually moving the viewpoint for the image 2b toward a position at which the image 2b is viewed from a diagonal direction, as shown in FIG. 12B.

Upon switching from the standard reproduction method to the eighth reproduction method, the control device 104 makes the image 2b appear to lift off the screen by gradually increasing the intensity of an advancing color (such as red) for the image 2b. The control device 104 adopting the eighth reproduction method may instead make the image 2b appear to sink deeper into screen by gradually increasing the intensity of a receding color (such as blue) for the image 2b.

In the second embodiment described above, upon detection of the user's hand 2a, the image 2b is altered through one of the reproduction methods among the third through eighth reproduction methods so as to take on an appearance of sinking deeper into the screen, allowing the user to experience a sensation of his hand 2a, held in front of the monitor 106, pushing the image 2b deeper into the screen. As an alternative, upon detection of the user's hand 2a, the image is made to take on an appearance of being lifted off the screen through a reproduction method among the third through eighth reproduction methods, thereby allowing the user to experience a sensation of his hand 2a, held in front of the monitor 106, pulling the image 2b toward the hand 2a.

In addition, upon detecting that the user's hand 2a has moved closer to the monitor 106, the control device 104 increases the extent to which the image 2b is made to appear to sink inward or the extent to which the image 2b is made appear to be lifted forward through a reproduction method among the third through eighth reproduction methods. As a result, the user, having moved his hand 2a toward the monitor 106, is able to experience a sensation of pushing the image 2a further away into the screen or a sensation of pulling the image 2b closer to the hand 2a.

If, on the other hand, the control device 104 detects that the user's hand 2a has moved further away from the monitor 106, it reduces the extent to which the image 2b is made to appear to sink inward or the extent to which the image 2b is made to appear to lift forward through a reproduction method among the third through eighth reproduction methods. As a result, the user, having moved his hand 2a further away from the monitor 106, is able to experience a sensation of the image 2b being pushed further away or being pulled forward by a lesser extent.

The following advantages are achieved through the second embodiment described above.

(1) The digital photo frame 100 includes a control device 104 that detects the user's hand 2a and a control device 104 that adjusts the method adopted to display the image 2b so as to alter the visual presentation of the image 2b along the front-back direction if the control device 104 detects the user's hand 2a. Thus, the image 2b can be displayed stereoscopic effect and the user is informed of detection of his hand 2a without compromising the viewability of the image.

(2) At the digital photo frame 100 described in (1) above, the control device 104 alters the visual representation of the image 2b along the depthwise direction by altering at least one of the size of the image 2b, the contrast of the image 2b, the shape of the image 2b, the extent to which the image 2b is smoothed, the position of the viewpoint and the color of the image 2b, thereby allowing the user to experience a sensation of the image 2b pulled toward the hand 2a or a sensation of the hand 2a pushing the image 2b deeper into the screen.

### Third Embodiment

In reference to drawings, the third embodiment of the present invention is described. The third embodiment is distinguishable from the first embodiment in the reproduction state adjustment processing executed for the image 2b and accordingly, the following detailed explanation focuses on the feature differentiating the third embodiment from the first embodiment. It is to be noted that features of the third embodiment other than the reproduction state adjustment processing executed for the image 2b are similar to those in the first embodiment and a repeated explanation thereof is not provided.

Upon detecting the user's hand 2a, the control device 104 achieved in the third embodiment adjusts the reproduction method for reproducing the image 2b so as to alter the reproduced image 2b currently on display along the direction of visually perceived depth (along the front-back direction).

In the third embodiment, the shape of the image 2b and the shape of the background area 5a displayed at the monitor 106 through the standard reproduction method are altered as the reproduction method is switched to a ninth reproduction method.

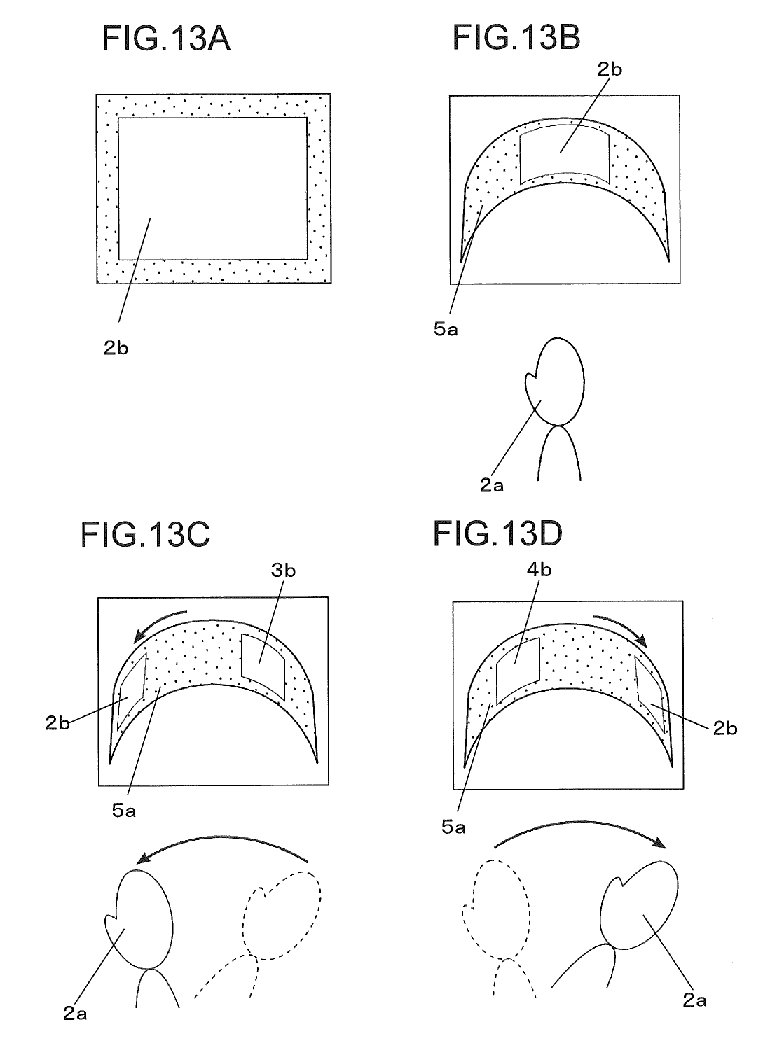

Once the standard reproduction method shown in FIG. 13A is switched to the ninth reproduction method, the control device 104 makes the image 2b and the background area 5a take on a stereoscopic appearance by curving the image 2b and the background area 5a until they each take on a semi-cylindrical shape, as shown in FIG. 13B. It is to be noted that the control device 104 assures good viewability for the image 2b on display by slightly tilting the plane of the semi-cylindrical image 2b frontward.

Subsequently, upon detecting that the user's hand 2a has moved sideways, the control device 104 switches the reproduced image 2b to another image in correspondence to the movement of the user's hand 2a.

For instance, the control device 104, having detected that the hand 2a has moved to the left, slides the image 2b to the left, as if to roll the image 2b downward along the contour of the background area 5a, as shown in FIG. 13C. At the same time, the control device 104 displays an image 3b immediately following the image 2b by sliding it to the left along the contour of the background area 5a.

If, on the other hand, the control device 104 detects that the hand 2a has moved to the right, it slides the image 2b to the right, as if to roll the image 2b downward along the contour of the background area 5a, as shown in FIG. 13D. At the same time, the control device 104 displays an image 4b immediately preceding the image 2b by sliding it to the right along the contour of the background area 5a.

As the image 2b is made to slide along the contour of the background area 5a as described above, the user is able to retain the stereoscopic perception of the image 2b and the background area 5a.

It is to be noted that the control device 104 may alter the speed at which the image 2b moves in correspondence to the contour of the background area 5a. For instance, the background area 5a in FIGS. 13A, 13B, 13C and 13D slopes gently around its center. Accordingly, the image 2b may be made to move more slowly around the center, whereas the image 2b may be made to move faster near an end of the background area 5a where it slopes more steeply.

The following advantages are achieved through the third embodiment described above.

(1) The digital photo frame 100 includes a control device 104 that detects the user's hand 2a and a control device 104 that adjusts the method adopted to display the image 2b so as to alter the visual presentation of the image 2b along the front-back direction if the control device 104 detects the user's hand 2a. Thus, the image 2b can be displayed with a stereoscopic effect and the user is informed of detection of his hand 2a without compromising the viewability of the image.

(2) The digital photo frame 100 described in (1) above includes a control device 104 which detects a movement of the user's hand 2a and further includes a control device 104 that manipulates the image 2b in correspondence to the movement of the user's hand 2a detected by the control device 104. This structure enables the user to issue an instruction for manipulating the image 2b in an intuitive manner with a simple gesture of his hand 2a.

(3) The control device 104 in the digital photo frame 100 described in (2) above, having detected the user's hand 2a, switches to a display method whereby the background area 5a set around the image 2b, as well as the image 2b itself, is visually altered along the front-back direction. As a result, both the image 2b and the background area 5z are made to take on a stereoscopic appearance, and the user is thus informed of detection of his hand 2a with even better clarity.

(4) The control device 104 in the digital photo frame 100 described in (3) above, having detected the movement of the user's hand 2a while the image 2b and the background area 5a are displayed in the alternative mode, moves the image 2b along the contour of the background area 5a in correspondence to the movement of the user's hand 2a, allowing the user to retain the stereoscopic perception of the image 2b and the background area 5a.

### Fourth Embodiment

In reference to drawings, the fourth embodiment of the present invention is described. The fourth embodiment is distinguishable from the first embodiment in the reproduction state adjustment processing executed for the image 2b and accordingly, the following detailed explanation focuses on the feature differentiating the fourth embodiment from the first embodiment. It is to be noted that features of the fourth embodiment other than the reproduction state adjustment processing executed for the image 2b are similar to those in the first embodiment and a repeated explanation thereof is not provided.

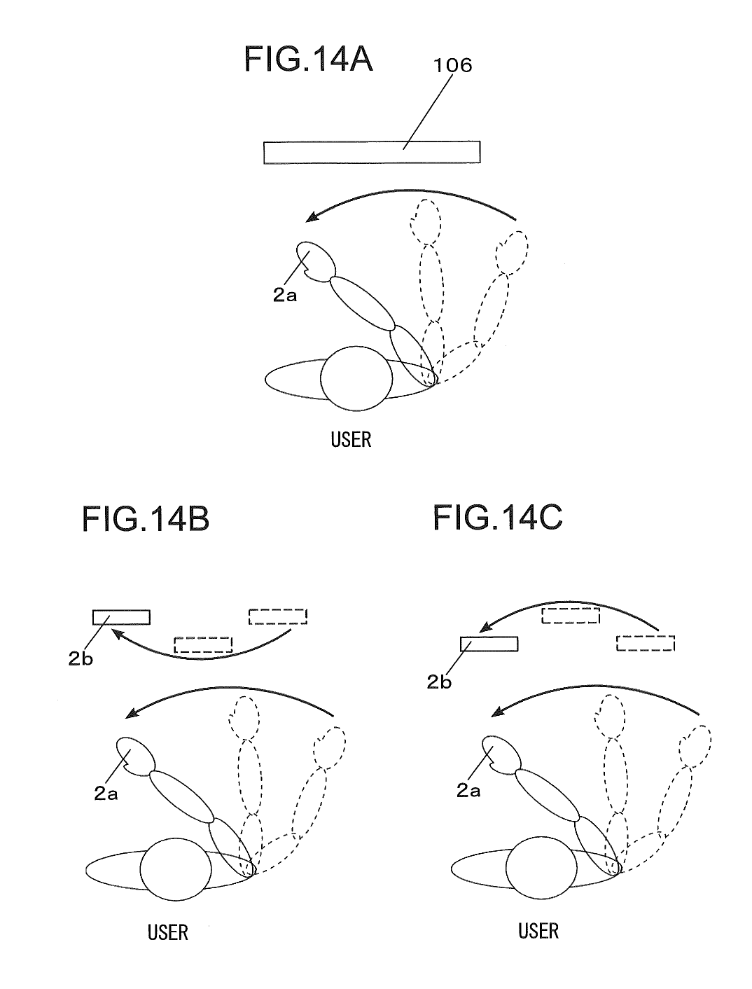

When the user moves his hand 2a sideways, the hand 2a moves in a circular arc formed with the fulcrum thereof assumed at, for instance, his shoulder, so as to approach and move away from the monitor 106 along the depth thereof, as shown in FIG. 14A. Accordingly, the image 2b is displayed in the fourth embodiment so as to appear to move in a circular arc by assuming different positions along the depthwise direction, as the hand 2a moves in the lateral direction.

For instance, the control device 104 may display the image 2b, as shown in FIG. 14B, so that the image 2b appears to move closer to the hand 2a approaching the monitor 106 and that the image 2b appears to move further away as the hand 2a moves away from the monitor 106. In this case, as the image 2b appears to move by interlocking with the movement of the hand 2a, the user is able to experience a sensation of the image 2b being pulled toward the hand from the screen.

As an alternative, the control device 104 may display the image 2b, as shown in FIG. 14C, so that the image 2b appears to move away as the hand 2a approaches the monitor 106 and that the image 2b appears to move closer as the hand 2a moves away from the monitor 106, as shown in FIG. 14C. In this case, as the image 2b appears to move by interlocking with the movement of the hand 2a, the user is able to experience a sensation of the image 2b being pushed deeper into the screen by the hand.

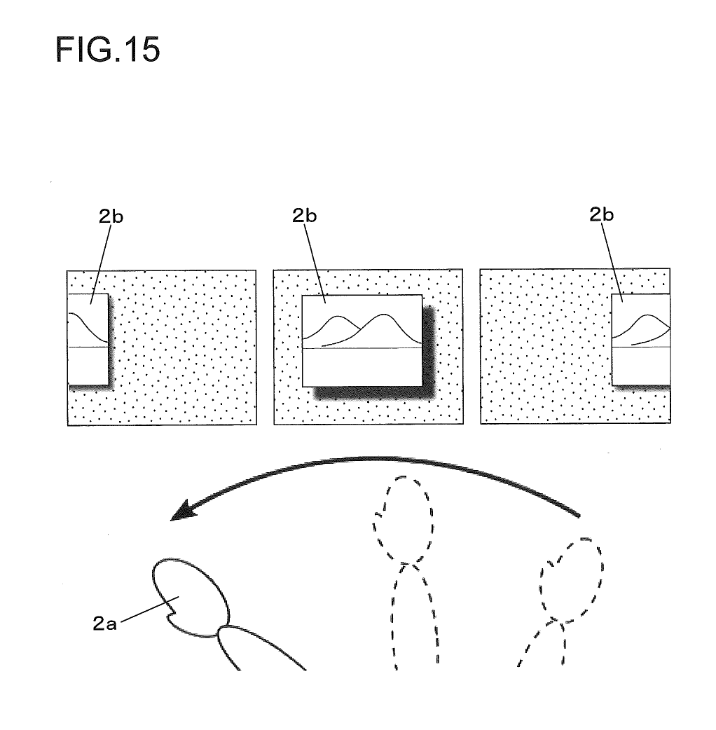

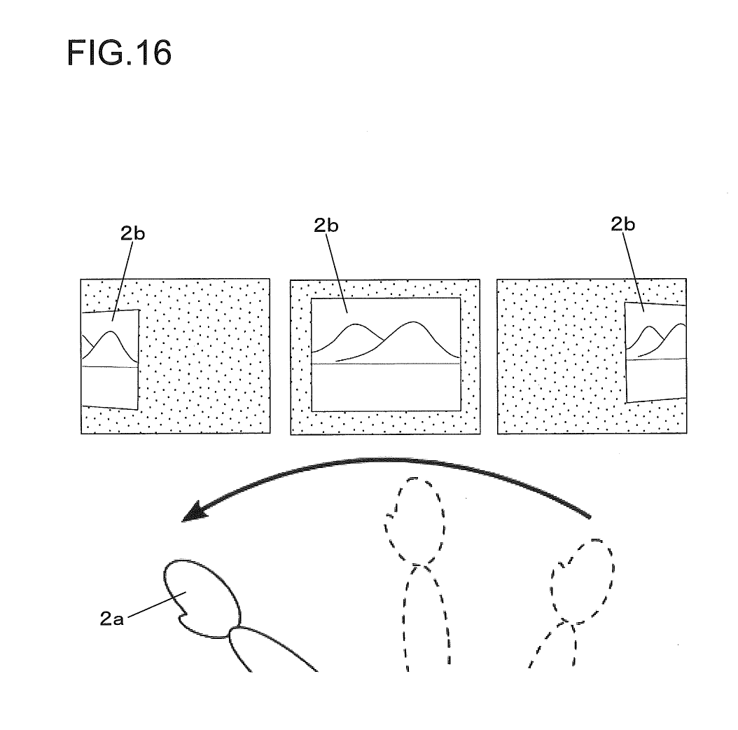

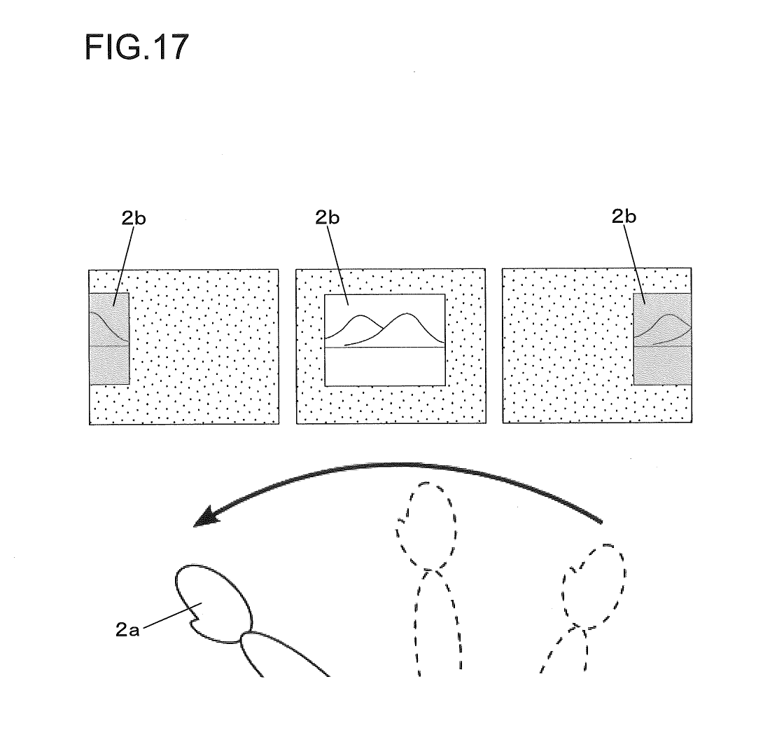

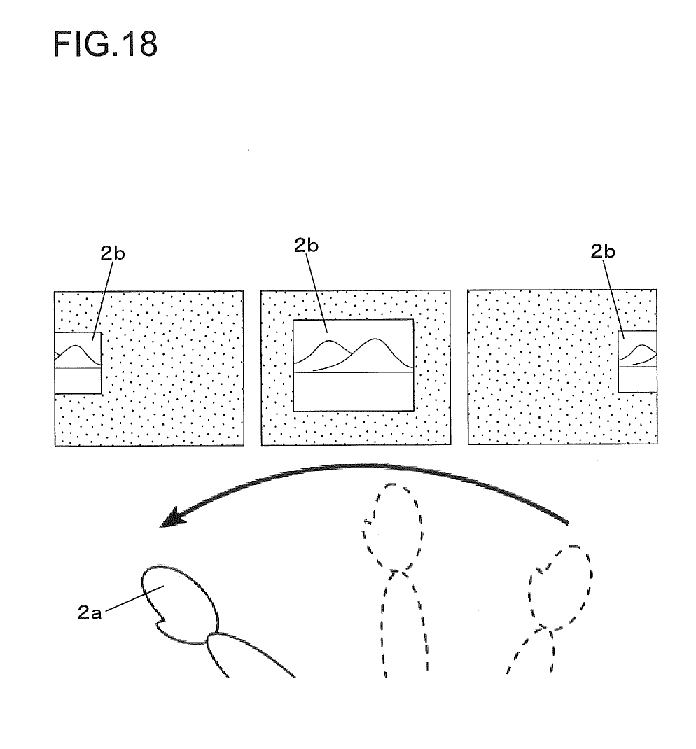

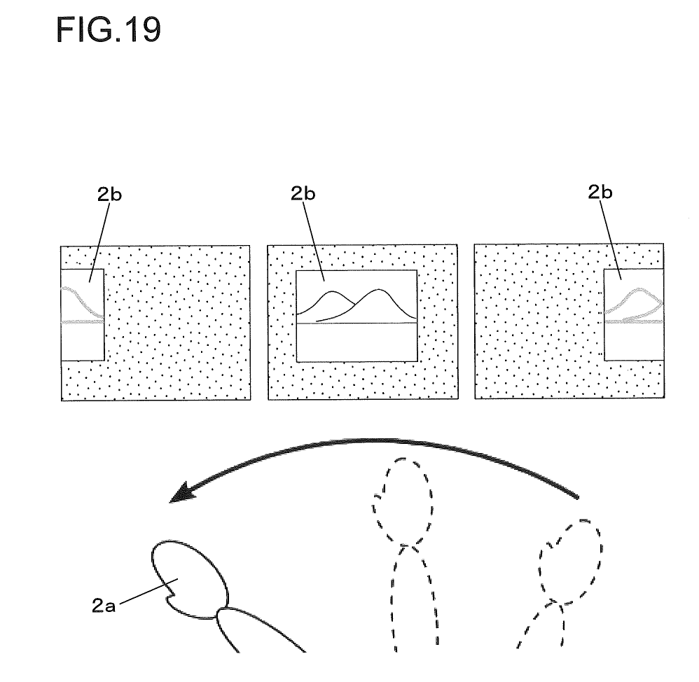

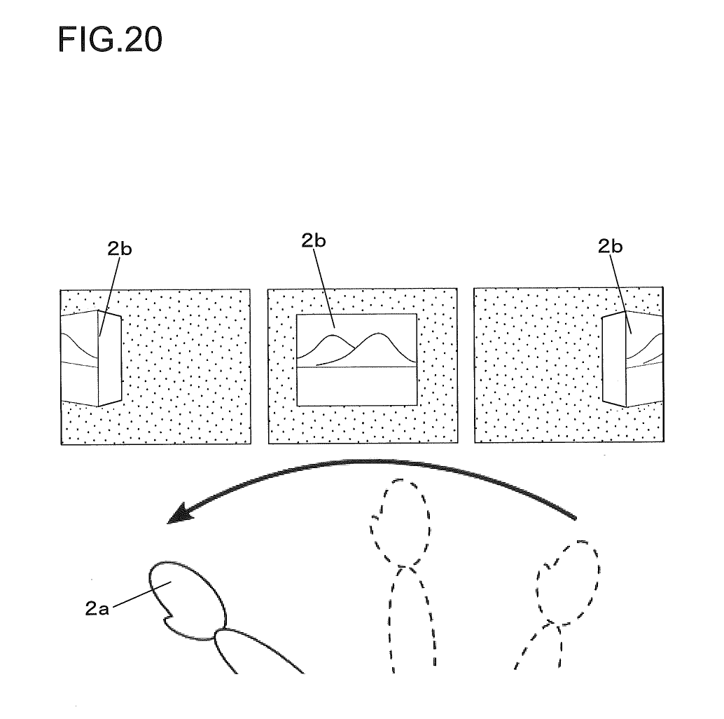

In the fourth embodiment, the image 2b is reproduced as shown in FIG. 14B or FIG. 14C by switching to a tenth reproduction method (see FIG. 15) whereby the shadow added to the image 2b is altered, and eleventh reproduction method (see FIG. 16) whereby a perspective rendition is applied to the image 2b, a twelfth reproduction method (see FIG. 17) whereby the contrast of the image 2b is altered, a thirteenth reproduction method (see FIG. 18) whereby the size of the image 2b is altered, a fourteenth reproduction method (see FIG. 19) whereby the extent to which the image 2b is smoothed is altered, a fifteenth reproduction method (see FIG. 20) whereby the viewpoint assumed for the image 2b is altered or a sixteenth reproduction method whereby the color of the image 2b is altered.

The control device 104 adjusts the reproduction method for the image 2b by switching from the standard reproduction method to one of the tenth through sixteenth reproduction methods upon detecting the user's hand 2a. It is to be noted that a setting indicating a specific reproduction method, i.e., one of the tenth through sixteenth reproduction methods to be switched to upon detecting the hand 2a, is selected in advance.

In addition, while the following explanation is given by assuming that the image is reproduced as shown in FIG. 14B through the tenth through sixteenth reproduction methods, the image may instead be reproduced as shown in FIG. 14C in the tenth through sixteenth reproduction methods. Furthermore, the image display apparatus may assume a structure that allows a switchover from the reproduction mode shown in FIG. 14B to the reproduction mode shown in FIG. 14C and vice versa.

In the tenth reproduction method shown in FIG. 15, the control device 104, having detected the hand 2a, adds a shadow to the image 2b. Subsequently, upon detecting that the hand 2a has moved sideways, the control device 104 moves the image 2b along the direction in which the hand 2a has moved. It reduces the size of the shadow as the image 2b moves closer to the left end or the right end of the screen, and maximizes the size of the shadow for the image assuming a position toward the center of the screen. As a result, the image 2b moving closer to the left end or the right end of the screen is made to appear to move away from the hand 2a, whereas the image 2b moving closer to the center of the screen is made to appear to move closer to the hand 2a.

In the eleventh reproduction method shown in FIG. 16, the control device 104, having detected the hand 2a, enlarges the image 2b. Then, upon detecting that the hand 2a has moved sideways, the control device 104 moves the image 2b along the direction in which the hand 2a has moved. In addition, it displays the image 2b with perspective by altering its shape so that it assumes a lesser height toward the end of the screen relative to the image height assumed toward the center of the screen as the image 2b moves closer to the left end or the right end of the screen. As a result, the image 2b takes on an appearance of moving further away from the hand 2a as it approaches the left end or the right end of the screen and moving closer to the hand 2a as it approaches the center of the screen.

In the twelfth reproduction method shown in FIG. 17, the control device 104 having detected the user's hand 2a leaves the standard reproduction method in effect. Subsequently, upon detecting that the hand 2a has moved sideways, the control device 104 moves the image 2b along the direction in which the hand 2a has moved and also gradually lowers the contrast of the image 2b as it moves closer to the left end or the right end of the screen but gradually raises the contrast of the image as it moves toward the center of the screen. As a result, the image 2b takes on an appearance of moving further away from the hand 2a as it approaches the left end or the right end of the screen and moving closer to the hand 2a as it approaches the center of the screen.

In the thirteenth reproduction method shown in FIG. 18, the control device 104 having detected the user's hand 2a leaves the standard reproduction method in effect. Subsequently, upon detecting that the hand 2a has moved sideways, the control device 104 moves the image 2b along the direction in which the hand 2a has moved and also gradually reduces the size of the image 2b as it moves closer to the left end or the right end of the screen but gradually increases the size of the image as it moves toward the center of the screen. As a result, the image 2b takes on an appearance of moving further away from the hand 2a as it approaches the left end or the right end of the screen and moving closer to the hand 2a as it approaches the center of the screen.

In the fourteenth reproduction method shown in FIG. 19, the control device 104 having detected the user's hand 2a leaves the standard reproduction method in effect. Subsequently, upon detecting that the hand 2a has moved sideways, the control device 104 moves the image 2b along the direction in which the hand 2a has moved. It also gradually increases the extent to which the image 2b is smoothed as it moves closer to the left end or the right end of the screen but gradually decreases the extent to which the image 2b is smoothed as it moves toward the center of the screen. As a result, the image 2b takes on an appearance of moving further away from the hand 2a as it approaches the left end or the right end of the screen and moving closer to the hand 2a as it approaches the center of the screen.

In the fifteenth reproduction method shown in FIG. 20, the control device 104 having detected the user's hand 2a leaves the standard reproduction method in effect. Subsequently, upon detecting that the hand 2a has moved to the left, the control device 104 moves the image 2b to the left and also shifts the position of the viewpoint further to the right as the image 2b moves closer to the left end of the screen. Upon detecting that the hand 2a has moved to the right, on the other hand, the control device 104 moves the image 2b to the right and also shifts the position of the viewpoint further to the left as the image 2b moves closer to the right end of the screen. As a result, the image 2b takes on an appearance of moving further away from the hand 2a as it approaches the left end or the right end of the screen and moving closer to the hand 2a as it approaches the center of the screen.

In the sixteenth reproduction method, the control device 104 having detected the user's hand 2a leaves the standard reproduction method in effect. Subsequently, upon detecting that the hand 2a has moved sideways, the control device 104 moves the image 2b along the direction in which the hand 2a has moved. It also alters the color of the image 2b so as to gradually intensify the hue of a receding color (such as blue) as the image 2b moves closer to the left end or the right end of the screen but alters the color of the image so as to gradually intensify the hue of an advancing color (such as red) as the image moves closer to the center of the screen. As a result, the image 2b takes on an appearance of moving further away from the hand 2a as it approaches the left end or the right end of the screen and moving closer to the hand 2a as it approaches the center of the screen.

The control device 104 achieved in the fourth embodiment as described above is able to display the image 2b through a display method more effectively interlocking with the movement of the hand 2a by setting the distance between the hand 2a and the image 2b along the perceived depthwise direction in correspondence to the position of the hand 2a assumed along the lateral direction.

The following advantages are achieved through the fourth embodiment described above.

(1) The digital photo frame 100 includes a control device 104 that detects the user's hand 2a and a control device 104 that adjusts the method adopted to display the image 2b so as to alter the visual presentation of the image 2b along the front-back direction if the control device 104 detects the user's hand 2a. Thus, the image 2b can be displayed with a stereoscopic effect and the user is informed of detection of his hand 2a without compromising the viewability of the image.

(2) The digital photo frame 100 described in (1) above includes a control device 104, which detects a movement of the user's hand 2a and further includes a control device 104 that manipulates the image 2b in correspondence to the movement of the user's hand 2a detected by the control device 104. This structure enables the user to issue an instruction for manipulating the image 2b in an intuitive manner with a simple gesture of his hand 2a.

(3) The control device 104 in the digital photo frame 100 structured as described in (2) above moves the image 2b while altering the perceived distance to the image 2b along the direction of visually perceived depth, in correspondence to a movement of the user's hand 2a. The control device 104 thus enables the user to intuit that the image 2b can be manipulated by interlocking with movements of his hand 2a.

(4) The control device 104 in the digital photo frame 100 achieved as described in (3) above alters the perceived distance to the image 2b along the direction of visually perceived depth by altering at least one of; the size of a shadow added to the image 2b, the size of the image 2b, the contrast of the image 2b, the shape of the image 2b, the extent to which the image 2b is smoothed, the position of the viewpoint and the color of the image 2b, in correspondence to a movement of the user's hand 2a. As a result, the user is able to experience a sensation of the image 2b, moving by interlocking with the movement of his hand 2a, being pulled forward or pushed back into the screen.

### Fifth Embodiment

In reference to drawings, the fifth embodiment of the present invention is described. The fifth embodiment is distinguishable from the first embodiment in the reproduction state adjustment processing executed for the image 2b and accordingly, the following detailed explanation focuses on the feature differentiating the fifth embodiment from the first embodiment. It is to be noted that features of the fifth embodiment other than the reproduction state adjustment processing executed for the image 2b are similar to those in the first embodiment and a repeated explanation thereof is not provided.

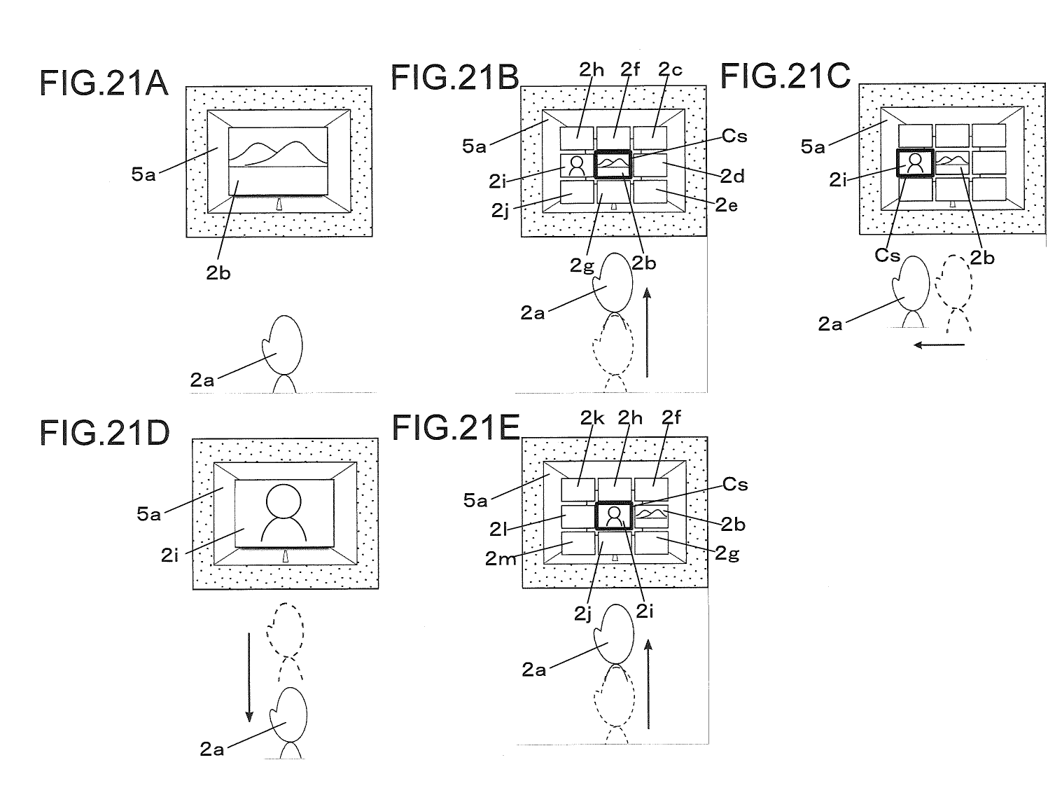

The control device 104 achieved in the fifth embodiment, having detected the user's hand 2a, makes the image 2b take on an appearance of sinking deeper along a perspective effect in the background area 5a, as shown in FIG. 21A.

Subsequently, upon detecting that the hand 2a has moved closer to the monitor 106, the control device 104 gradually reduces the size of the image 2b on display and also displays a plurality of images (2c through 2j) preceding and following the image 2b in a reduced size around the image 2b, as shown in FIG. 21B. In other words, a thumbnail display of the images 2b through 2j, arranged in a grid pattern (e.g., a 3×3 grid pattern) is brought up at the monitor 106. It is to be noted that the term “thumbnail display” is used to refer to a display mode in which reduced images referred to as thumbnails are displayed side-by-side. As a result, the image 2b takes on an appearance of having sunk even deeper into the screen. In addition, the control device 104 displays a cursor Cs as a rectangular frame set around the image 2b. The cursor Cs is used to select a specific thumbnail image.

Subsequently, upon detecting that the hand 2a has moved up, down, to the left or to the right, the control device 104 moves the cursor Cs along the direction in which the hand 2a has moved. For instance, if the hand 2a in the state shown in FIG. 21B then moves to the left, the cursor Cs is moved to the image 2i directly to the left of the image 2b, as shown in FIG. 21C.

If the control device 104 detects, in this state, that the hand 2a has moved further away from the monitor 106, it brings up an enlarged display of the image 2i alone, selected with the cursor Cs at the time point at which the retreating hand 2a has been detected, as shown in FIG. 21D. At this time, the control device 104 displays the enlarged image 2i so that it appears to sink inward along the perspective effect in the background area 5a.

Subsequently, upon detecting that the hand 2a has again moved closer to the monitor 106, the control device 104 gradually reduces the size of the reproduced image 2i on display and also displays a plurality of images (2b, 2f through 2h, 2j through 2m) preceding and following the image 2i in a reduced size around the image 2i, as shown in FIG. 21E.

In this state, if the control device 104 detects that the hand 2a has moved sideways by a significant extent equal to or greater than a predetermined threshold value, the control device 104 slides the nine images (2b, 2f through 2m) currently on thumbnail display together along the direction in which the hand 2a has moved and also slides the preceding or following group of nine images so as to bring them up on display. It is to be noted that if the extent to which the hand 2a has moved sideways is less than the predetermined threshold value, the control device 104 moves the cursor Cs along the direction in which the hand 2a has moved, as explained earlier.

Furthermore, if the control device 104 detects, in the state shown in FIG. 21D, that the hand 2a has moved further away from the monitor 106, it resumes the standard reproduction method so as to display the image 2i through the standard reproduction method.

As described above, as the hand 2a moves closer to the monitor 106, the control device 104 switches to the thumbnail display so as to achieve a display effect whereby the image appears to sink deeper into the screen. The control device 104 thus enables the user to issue a thumbnail display instruction in an intuitive manner with a simple gesture of his hand 2a as if to push the image deeper into the screen.

Then, as the hand 2a moves up, down, to the left or to the right while the thumbnail display is up, the control device 104 moves the cursor Cs, whereas if the hand 2a moves sideways to a great extent while the thumbnail display is up, the control device 104 switches to a display of another batch of thumbnail images by sliding the current thumbnail images sideways. The user is thus able to issue an instruction for moving the cursor Cs or switching the thumbnail images in an intuitive manner with a simple gesture of his hand 2a.

In addition, if the hand 2a moves further away from the monitor 106 while the thumbnail display is up, the control device 104 enlarges the image selected with the cursor Cs so as to display the image so that it appears to be lifted off the screen. The control device 104 thus allows the user to issue an instruction for image enlargement in an intuitive manner with a simple gesture of his hand 2a as if to pull the image forward.

The following advantages are achieved through the fifth embodiment described above.

(1) The digital photo frame 100 includes a control device 104 that detects the user's hand 2a and a control device 104 that adjusts the display method adopted to display the image 2b so as to alter the visual presentation of the image 2b along the front-back direction if the control device 104 detects the user's hand 2a. Thus the image 2b can be displayed with a stereoscopic effect and the user is informed of detection of his hand 2a without compromising the viewability of the image.

(2) The digital photo frame 100 described in (1) above includes a control device 104, which detects a movement of the user's hand 2a and further includes a control device 104 that manipulates the image 2b in correspondence to the movement of the user's hand 2a detected by the control device 104. This structure enables the user to issue an instruction for manipulating the image 2b in an intuitive manner with a simple gesture of his hand 2a.

(3) The control device 104 in the digital photo frame 100 structured as described in (2) above, having detected a movement of the user's hand 2a toward the monitor 106 while the image 2b is displayed in the alternative mode, brings up on display a plurality of images 2b through 2j, including the image 2b, in a reduced size, so as to further alter the appearance of the image 2b along the direction of visually perceived depth. It thus allows the user to issue an instruction for displaying the image 2b in a reduced size in an intuitive manner with a simple gesture of his hand 2a.

(4) The control device 104 in the digital photo frame 100 structured as described in (3) above displays the cursor Cs to be used to select an image among the images 2b through 2j in the reduced display. Upon detecting that the user's hand 2a has moved up, down, to the left or to the right while the reduced display is up, the control device 104 moves the cursor Cs in correspondence to the detected movement. As a result, the user is able to issue an instruction for moving the cursor Cs in an intuitive manner with a simple gesture of his hand 2a.

(5) The control device 104 in the digital photo frame 100 structured as described in (4) above, having detected that the user's hand 2a has moved further away from the monitor 106 while the reduced display is up, brings up an enlarged display of the image selected with the cursor Cs, thereby allowing the user to issue an instruction for enlarged image display in an intuitive manner with a simple gesture of his hand 2a.

### Sixth Embodiment

In reference to drawings, the sixth embodiment of the present invention is described. The sixth embodiment is distinguishable from the first embodiment in the reproduction state adjustment processing executed for the image 2b and accordingly, the following detailed explanation focuses on the feature differentiating the sixth embodiment from the first embodiment. It is to be noted that features of the sixth embodiment other than the reproduction state adjustment processing executed for the image 2b are similar to those in the first embodiment and a repeated explanation thereof is not provided.

Upon detecting the user's hand 2a, the control device 104 achieved in the sixth embodiment adjusts the reproduction method for reproducing the image 2b so as to alter the reproduced image 2b along the direction of visually perceived depth (along the front-back direction).

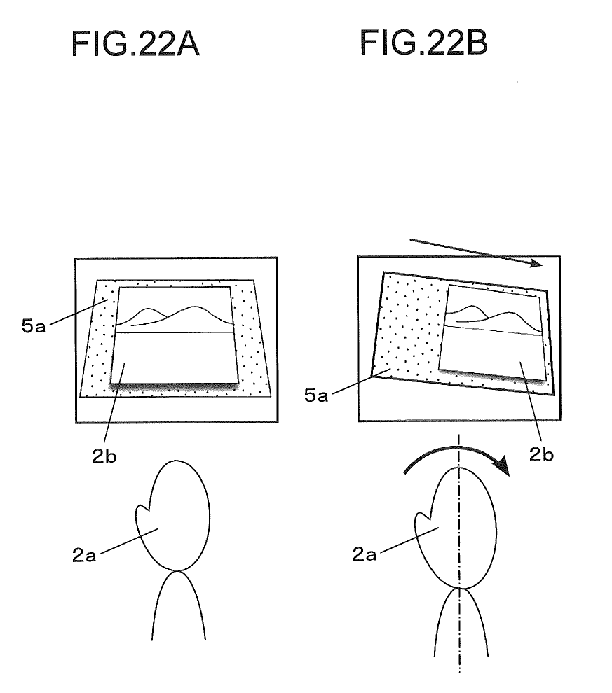

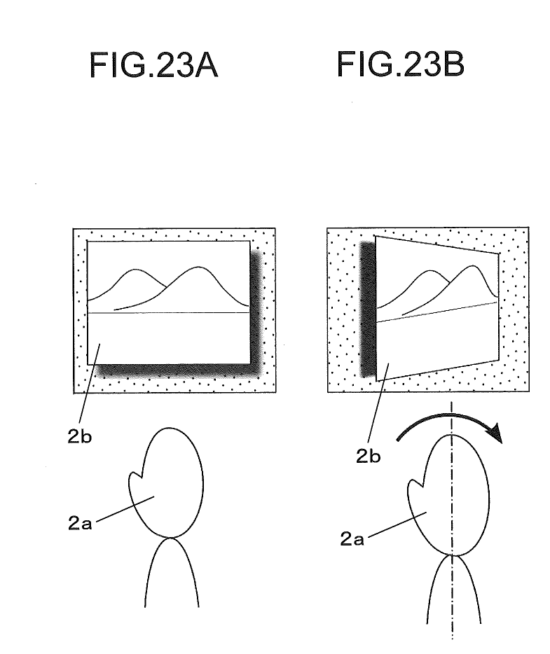

In the sixth embodiment, the standard reproduction method through which the image 2b is displayed at the monitor 106 initially can normally be switched to a seventeenth reproduction method (see FIGS. 22A and 22B) through which the image 2b is reproduced in a perspective rendition, or to an eighteenth reproduction method (see FIGS. 23A and 23B) through which a shadow is added to the image 2b.

The control device 104 adjusts the reproduction method for the image 2b by switching from the standard reproduction method to either the seventeenth reproduction method or the eighteenth reproduction method upon detecting the user's hand 2a. It is to be noted that a setting indicating a specific reproduction method, i.e., either the seventeenth or the eighteenth reproduction method to be switched to upon detecting the hand 2a, is selected in advance.

In the seventeenth reproduction method, the control device 104, having detected the user's hand 2a, alters the image 2b in a perspective rendition by reshaping the image 2b and the background area 5a so that their widths become gradually smaller deeper into the screen, as shown in FIG. 22A. As a result, the image 2b and the background area 5a take on a stereoscopic appearance of sliding deeper into the screen.

Subsequently, upon detecting a rotation of the hand 2a, the control device 104 switches the display from the image 2b to another image in conformance to the particular movement of the hand 2a. For instance, upon detecting a rightward rotation of the hand 2a, the control device 104 tilts the background area 5a to the right and slides the image 2b to the right so as to roll it down along the contour of the background area 5a, as illustrated in FIG. 22B. At the same time, it slides the image (not shown) immediately preceding the image 2b to the right so as to bring it up on display. If, on the other hand, the control device 104 detects a leftward rotation of the hand 2a, the control device 104 tilts the background area 5a to the left and slides the image 2b to the left so as to roll it down along the contour of the background area 5a. It also slides the image (not shown) immediately following the image 2b to the left so as to bring it up on display.

As a result, the user is able to issue an image switch instruction in an intuitive manner simply by rotating his hand 2a. In addition, since the image 2b is made to slide along the contour of the background area 5a, the user is able to retain the stereoscopic perception of the image 2b and the background area 5a.

In the eighteenth reproduction method, the control device 104, having detected the user's hand 2a, alters the image 2b so that the image 2b takes on a stereoscopic appearance by adding a shadow to the image 2b as shown in FIG. 23A.

Subsequently, upon detecting a rotation of the hand 2a the control device 104 shifts the viewpoint taken for the image 2b in conformance to the movement of the hand 2a. For instance, upon detecting a rightward rotation of the hand 2a, the control device 104 shifts the viewpoint to a position at which the image 2b is viewed diagonally from the left, as illustrated in FIG. 23B. If, on the other hand, the control device 104 detects a leftward rotation of the hand 2a, the control device 104 shifts the viewpoint to a position at which the image 2b is viewed diagonally from the right.

The user is thus able to issue an instruction for moving the viewpoint taken for the image 2b in an intuitive manner simply by rotating his hand 2a.

The following advantages are achieved through the sixth embodiment described above.

(1) The digital photo frame 100 includes a control device 104 that detects the user's hand 2a and a control device 104 that adjusts the method adopted to display the image 2b so as to alter the visual presentation of the image 2b along the front-back direction if the control device 104 detects the user's hand 2a. Thus, the image 2b can be displayed with a stereoscopic effect and the user is informed of detection of his hand 2a without compromising the viewability of the image.

(2) The digital photo frame 100 described in (1) above includes a control device 104, which detects a movement of the user's hand 2a and further includes a control device 104 that manipulates the image 2b in correspondence to the movement of the user's hand 2a detected by the control device 104. This structure enables the user to issue an instruction for manipulating the image 2b in an intuitive manner with a simple gesture of his hand 2a.

(3) The control device 104 in the digital photo frame 100 structured as described in (2) above, having detected a rotation of the user's hand 2a, switches the display from the image 2b to another image or shifts the viewpoint taken for the image 2b in correspondence to the detected rotation, thereby enabling the user to issue an instruction for manipulating the image 2b in an intuitive manner simply by rotating his hand 2a.

(Variations)

It is to be noted that the cameras achieved in the embodiments described above allow for the following variations.

(1) The digital photo frame 100 achieved in each of the embodiments described above includes a storage medium 105 constituted with a nonvolatile memory such as a flash memory and the reproduction target image data are recorded into this storage medium 105. However, the digital photo frame 100 may adopt an alternative structure that includes a memory card slot and image data recorded in a memory card being loaded in the memory card slot, instead of image data recorded in the storage medium 105, may be designated as a reproduction target.

(2) The control device 104 achieved in an embodiment described earlier alters the size of a shadow added to the image or the extent to which the image is made to appear to sink deeper into the screen depending upon whether the user's hand 2a moves closer to or further away from the monitor 106, as illustrated in FIGS. 4A, 4B and 4C and FIGS. 5A, 5B and 5C. However, the present invention is not limited to these examples and the control device 104 may continuously alter the size of the shadow or the extent to which the image is made to appear to sink into the screen in correspondence to the length of time over which the user holds his hand 2a in front of the monitor. For instance, while the image 2b is reproduced through the first method described earlier, the control device 104 may gradually increase the size of the shadow at the reproduced image 2b on display as the length of time elapsing after the user's hand 2a is first detected increases. In this case, the user is able to experience a sensation of the image 2b being pulled closer to his hand as he holds his hand in front of the monitor 106 over an extended length of time. As an alternative, while the image 2b is reproduced through the second method described earlier, the control device 104 may gradually make the reproduced image 2b on display appear to gradually sink deeper as the length of time elapsing after the user's hand 2a is first detected increases. In this case, the user is able to experience a sensation of the image 2b being pushed into the screen, further away from his hand as he holds his hand in front of the monitor 106 over an extended length of time.

(3) The control device 104 achieved in the embodiment described above switches to a specific reproduction method upon detecting the user's hand 2a in correspondence to a preselected setting indicating which reproduction method, i.e., either the first reproduction method or the second reproduction method, to switch to upon detecting the hand 2a. As an alternative, the control device 104 may keep the standard reproduction method in place without switching to another reproduction method when the user's hand 2a is detected and then, upon detecting that the user's hand 2a has moved away from the monitor 106, it may switch to the first reproduction method, whereas upon detecting that the user's hand 2a has moved closer to the monitor 106, it may switch to the second reproduction method. In this case, the user is able to experience a sensation of the image 2b being pulled toward his hand moving away from the monitor 106 and a sensation of the image 2b being pushed deeper into the screen by his hand moving closer to the monitor 106.

As a further alternative, the control device 104 may select either the first reproduction method or the second reproduction method depending upon the type of reproduced image 2b that is currently on display. For instance, if the reproduced image 2b is a landscape, the control device may switch to the second reproduction method upon detecting the user's hand 2a, whereas if the reproduced image 2b is an image other than a landscape, the control device may switch to the first reproduction method upon detecting the user's hand 2a. Through these measures, the user viewing a reproduced image of a landscape located away from the user is allowed to experience a sensation of the image 2b on display sinking further away from the user.

(4) The embodiments have been described by assuming that a single hand 2a belonging to a given user is detected in an image obtained by the camera 102. However, it is conceivable that a plurality of hands is detected. In such a case, the control device 104 should execute the processing described above in conjunction with a selected target hand. For instance, the control device 104 may designate the hand present at a position closest to the center of the image as the target hand or may designate the hand taking up the largest area within the image as the target hand. As an alternative, the control device 104 may designate the hand that is detected first as the target hand.

(5) The embodiments have been each described by assuming that the camera 102, disposed on the front side of the digital photo frame 100, photographs the user facing the digital photo frame 100, as shown in FIG. 2. However, the position of the user assumed relative to the camera 102 is bound to vary, and the user may stand at a position at which the user's hand 2a remains outside the angular field of view of the camera 102. In order to address this issue, the camera 102 may adopt a swivel structure that will allow the camera 102 to seek an optimal camera orientation at which it is able to detect the user's hand 2a. As an alternative, the user may be informed that his hand 2a is outside the angular field of view of the camera 102 and be prompted to move into the angular field of view of the camera 102. In this case, the user may be alerted by a sound output through a speaker (not shown) or with a message displayed on the monitor 106. Then, as the user's hand 2a moves within the detection range, a sound or a message may be output again or the image 2b on display may be framed for emphasis so as to inform the user that the hand 2a is now within the detection range.

(6) The control device 104 achieved in the various embodiments described above switches from the currently reproduced image to another image upon detecting a lateral movement of the user's hand 2a. However, an operation other than the image switching operation may be enabled upon detecting a lateral hand movement. For instance, the image 2b may be enlarged or reduced in correspondence to the movement of the user's hand.

(7) The control device 104 achieved in the various embodiments described above, having detected the user's hand 2a, switches to an alternative reproduction method so as to reproduce the image 2b through another method and manipulates the reproduced image 2b on display in correspondence to a movement of the user's hand 2a. However, the present invention is not limited to this example and the control device 104 may switch to an alternative reproduction method so as to reproduce the image 2b through another method upon detecting a target object other than the user's hand 2a and manipulate the reproduced image 2b on display in correspondence to a movement of the target object. For instance, the user may hold a pointer in front of the monitor 106, and in such a case, the control device 104, having detected the pointer as the target object, may switch to the alternative reproduction method so as to reproduce the image 2b through another method and manipulate the reproduced image 2b in correspondence to a movement of the pointer. Under these circumstances, it is not structurally necessary to execute the matching processing in conjunction with a template image as has been described earlier. Accordingly, the control device 104 may operate in conjunction with a radiating unit that radiates infrared light to the digital photo frame 100 and an infrared sensor that receives reflected infrared light so as to detect the presence of the target object when the infrared sensor receives reflected infrared light, initially radiated from the radiating unit, in a quantity equal to or greater than a predetermined quantity.

(8) In the embodiments described above, the background area 5a is set around the reproduced image 2b. As an alternative, the control device 104 may set the background area 5a around the reproduced image 2b in conjunction with the second reproduction method alone, without setting the background area 5a around the reproduced image 2b reproduced through the standard reproduction method or the first reproduction method.

(9) The image display apparatus according to the present invention is embodied as a digital photo frame in the description provided above. However, the present invention is not limited to this example and it may instead be adopted in another apparatus, such as a digital camera or a portable telephone that is equipped with a camera used to photograph a user and a monitor at which images are displayed, and has an image reproduction function. Furthermore, the present invention may be equally effectively adopted in a television set or a projector apparatus used to project images.

(10) The second embodiment has been described by assuming that the specific reproduction method, among the third through eighth reproduction methods, to be switched to upon detecting the user's hand 2a is a preselected. As an alternative, the control device 104 may adopt a plurality of reproduction methods, among the third through eighth reproduction methods, in combination. For instance, it may reproduce the image 2b by combining the third reproduction method and the fourth reproduction method so as to gradually reduce the size of the image 2b while gradually lowering the contrast of the image 2b as well. In such a case, the visually perceived depth of the image 2b can be further increased.

(11) The fourth embodiment has been described by assuming that the specific reproduction method, among the tenth through sixteenth reproduction methods, to be switched to upon detecting the user's hand 2a is a preselected. As an alternative, the control device 104 may adopt a plurality of reproduction methods, among the tenth through sixteenth reproduction methods, in combination. For instance, it may reproduce the image 2b by combining the twelfth reproduction method and the thirteenth reproduction method so as to gradually reduce the size of the image 12 as it moves closer to the left end or the right end of the screen while gradually lowering the contrast of the image and to gradually enlarge the image 2b as it moves closer to the center of the screen while gradually increasing the contrast of the image. In such a case, the visually perceived depth of the image 2b can be further increased.

(12) In the second embodiment described earlier, the image 2b is altered so as to gradually take on a spherical shape through the fifth reproduction method. However, the present invention is not limited to this example and the image may be altered to assume a polygonal shape or a cylindrical shape, as long as the image 2b is altered into a shape with a projecting plane or a recessed plane with which spatial depth can be expressed.

(13) It is to be noted that while the image is manipulated in conformance to a hand movement in the embodiments described above, the image may be manipulated in response to a finger gesture in addition to the hand movement. For instance, upon detecting that the fingers, having been clenched together in a fist, have opened out, the image currently on display may be enlarged, whereas upon detecting that the hand, having been in the open palm state, has closed into a fist, the image on display may be reduced. In addition, a video image may be controlled in correspondence to the number of fingers held up in front of the monitor by, for instance, playing back the video at regular speed if the user holds up one finger, playing back the video at double speed if the user holds up two fingers and playing back the video at quadruple speed if the user holds up three fingers. Through these measures, a greater variation of image operations can be enabled.

In addition, while the image is manipulated in response to a hand movement in the embodiments described earlier, the image may be manipulated in a similar manner in response to a head movement instead of a hand movement. In this case, even when user's hands are busy operating a keyboard or a mouse to operate a personal computer and cannot, therefore, issue instructions for image operations through hand movements, he will be able to manipulate the image by moving his head.

It is to be noted that while the image is manipulated in response to a hand movement in the embodiments described above, the image may instead be manipulated in response to a movement of an object (such as pen) held in the user's hand.

As long as the features characterizing the present invention are not compromised, the present invention is not limited in any way whatsoever to the particulars of the embodiments described above. In addition, a plurality of the embodiments described above may be adopted in combination or any of the embodiments described above may be adopted in conjunction with a plurality of variations.

### Seventh Embodiment

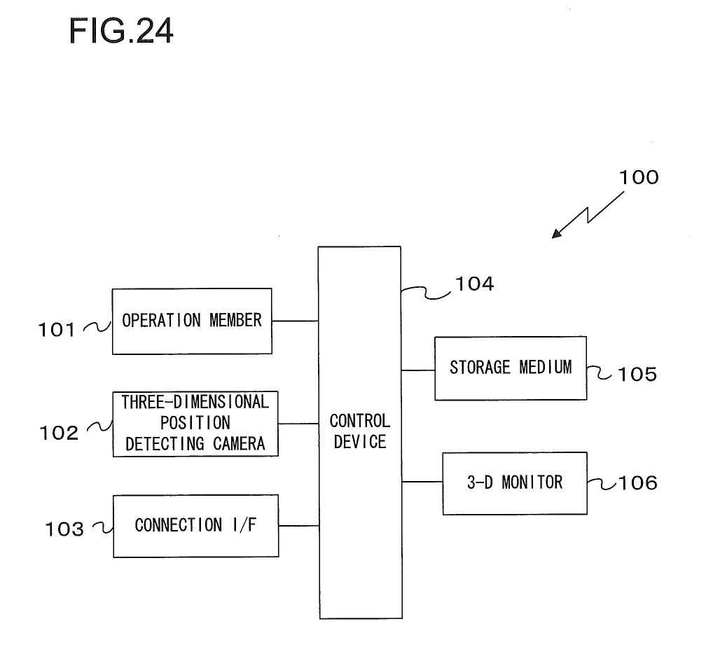

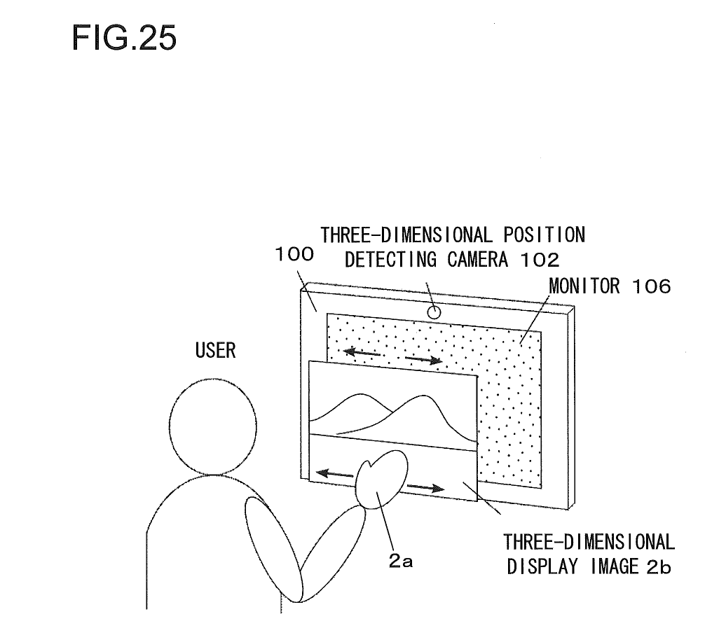

FIG. 24 is a block diagram showing the structure of the image display apparatus achieved in the seventh embodiment. The image display apparatus may be embodied as, for instance, a digital photo frame 100 such as that shown in FIG. 25. The digital photo frame 100 comprises an operation member 101, a three-dimensional position detecting camera 102, a connection I/F (interface) 103, a control device 104, a storage medium 105 and a 3-D monitor 106.

The operation member 101 includes various devices, such as operation buttons, operated by the user of the digital photo frame 100. As an alternative, a touch panel may be mounted at the 3-D monitor 106 so as to enable the user to operate the digital photo frame via the touch panel.

The three-dimensional position detecting camera 102 is capable of detecting the three-dimensional position of a subject. It is to be noted that the three-dimensional position detecting camera 102 may be, for instance, a single lens 3-D camera, a double lens 3-D camera, a distance image sensor, or the like. With the three-dimensional position detecting camera 102, which is disposed on the front side of the digital photo frame 100, as shown in FIG. 25, the user facing the digital photo frame 100 can be photographed. Image signals output from the image sensor in the three-dimensional position detecting camera 102 are output to the control device 104, which then generates image data based upon the image signals.

The connection I/F 103 is an interface via which the digital photo frame 100 establishes a connection with an external device. The digital photo frame 100 in the embodiment is connected with an external device with image data recorded therein, such as a digital camera, via the connection I/F 103. The control device 104 takes in image data from the external device via the connection I/F 103 and records the image data thus taken in into the storage medium 105. It is to be noted that the connection I/F 103 may be a USB interface via which a wired connection between the external device and the digital photo frame 100 is established, a wireless LAN module via which the external device and the digital photo frame 100 can be connected with each other wirelessly, or the like. As an alternative, the image display apparatus may include a memory card slot instead of the connection I/F 103, and in such a case, image data can be taken into the image display apparatus as a memory card with image data recorded therein is loaded in the memory card slot.

The control device 104, constituted with a CPU, a memory and other peripheral circuits, executes overall control for the digital photo frame 100. It is to be noted that the memory constituting part of the control device 104 is a volatile memory such as an SDRAM. This memory includes a work memory where a program is opened when the CPU executes the program and a buffer memory where data are temporarily recorded.

In the storage medium 105, which is a nonvolatile memory such as a flash memory, a program executed by the control device 104, image data having been taken in via the connection I/F 103, and the like are recorded. At the 3-D monitor 106, capable of providing a three-dimensional display, a reproduction target image 2b can be displayed with a 3-D effect, as shown in FIG. 25. It is to be noted that the image 2b may be brought up in a two-dimensional display instead of in a three-dimensional display at the 3-D monitor 106. In addition, the monitor capable of providing a three-dimensional display may be, for instance, a 3-D monitor that provides a 3-D image display through a method of the known art, such as a naked-eye method or in conjunction with 3-D glasses.

The control device 104 in the digital photo frame 100 achieved in the embodiment detects the three-dimensional position of the user's hand 2a and any change occurring in the three-dimensional position from one frame to another based upon images captured with the three-dimensional position detecting camera 102 and adjusts the reproduction state of the image 2b in correspondence to the detection results. The following is a description of the reproduction state adjustment processing executed by the control device 104 to adjust the reproduction state of the image 2b in correspondence to the three-dimensional position of the user's hand 2a and any change occurring in the three-dimensional position from one frame to another. It is to be noted that the following description is given by assuming that the control device 104 brings up a two-dimensional display of the image 2b at the 3-D monitor 106 if the user's hand 2a is not captured in the images input from the three-dimensional position detecting camera 102 and shifts into a three-dimensional display upon detecting the hand 2a in an image input from the three-dimensional position detecting camera 102.

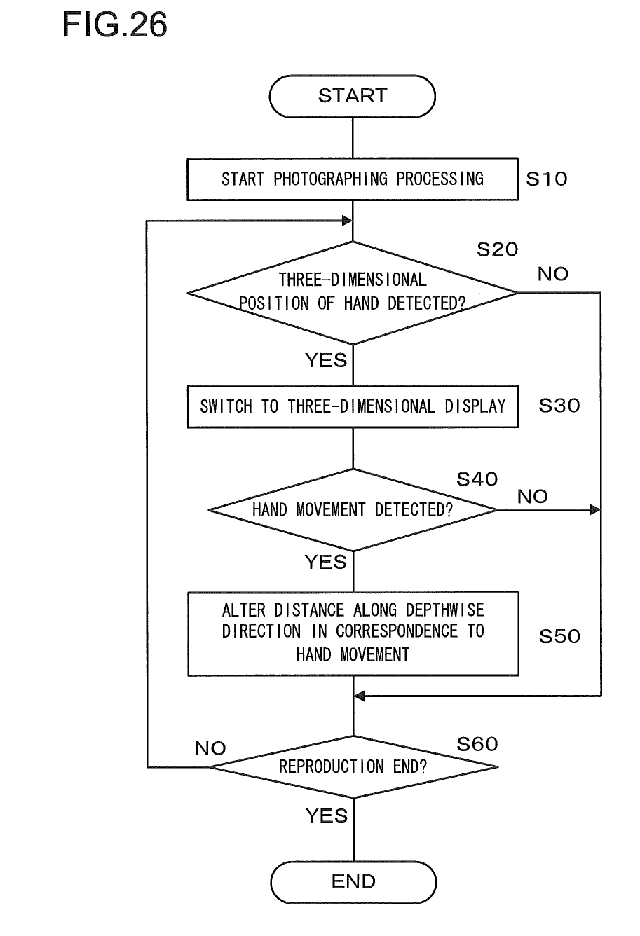

FIG. 26 presents a flowchart of the image reproduction state adjustment processing executed to adjust the image reproduction state in correspondence to the three-dimensional position of the user's hand 2a and a change in the three-dimensional position occurring from one frame to another. The processing shown in FIG. 26 is executed by the control device 104 as a program that is started up as reproduction of the image 2b starts at the 3-D monitor 106. It is to be noted that the three-dimensional position of the user's hand 2a is not yet detected at the time point at which the program execution starts, and accordingly, the image 2b is displayed as a two-dimensional image at the 3-D monitor 106, as explained earlier.

In step S10, the control device 104 starts photographing images via the three-dimensional position detecting camera 102. The three-dimensional position detecting camera 102 in the embodiment is engaged in photographing operation at a predetermined frame rate and thus, image data are successively input to the control device 104 from the three-dimensional position detecting camera 102 over predetermined time intervals corresponding to the frame rate. Subsequently, the operation proceeds to step S20.

In step S20, the control device 104 makes a decision, based upon the image data input from the three-dimensional position detecting camera 102, as to whether or not the three-dimensional position of the user's hand 2a has been detected in an input image. For instance, an image of the user's hand 2a may be recorded in advance as a template image, and, in such a case, the control device 104 is able to decide whether or not the user's hand 2a is included in the input image by comparing the input image to the template image through matching processing. If it is decided that the user's hand 2a is included in the input image, the three-dimensional position of the hand 2a can be detected. If a negative decision is made in step S20, the operation proceeds to step S60 to be described later. However, if an affirmative decision is made in step S20, the operation proceeds to step S30.

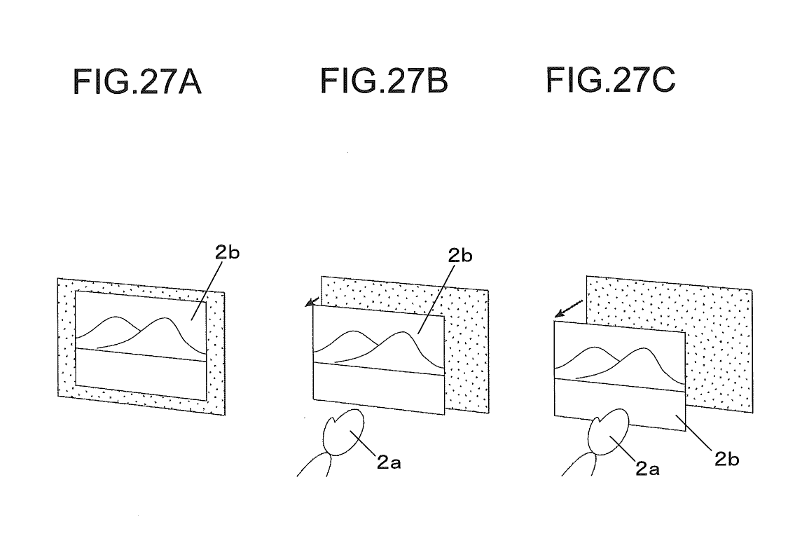

In step S30, the control device 104 switches the display mode from the two-dimensional display to the three-dimensional display so as to display the reproduced image 2b, currently displayed at the 3-D monitor 106, with a three-dimensional effect by visually altering the distance between the user and the reproduced image 2b along the depthwise direction (along the front-back direction). For instance, the control device 104 may bring up the three-dimensional display so as to make the image 2b appear to jump forward, as shown in FIG. 27B, by reducing the visually perceived distance between the reproduced image 2b, having been displayed as a two-dimensional image, and the user along the depthwise direction. As a result, the user is able to experience a sensation of the image 2b being pulled toward his hand held in front of the 3-D monitor 106. It is to be noted that the control device 104 may make the image 2b appear to jump out to a position very close to the user's hand 2a so as to allow the user to experience a sensation of almost touching the image 2b.

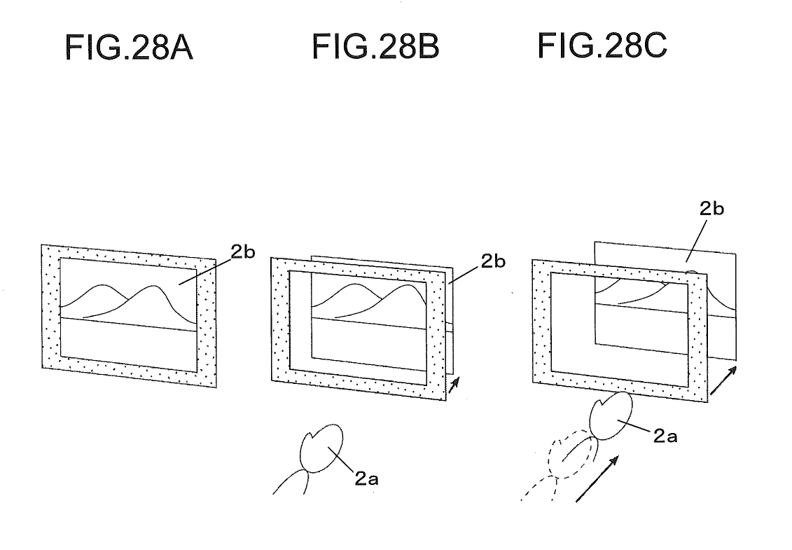

As an alternative, the control device 104 may bring up a three-dimensional display so as to make the image 2b appear to sink inward, as shown in FIG. 28B by increasing the visually perceived distance between the reproduced image 2b, having been displayed as a two-dimensional image, and the user along the depthwise direction. As a result, the user is able to experience a sensation of his hand, held in front of the 3-D monitor 106, pushing the image 2b deeper into the screen. It is to be noted that a setting, selected in advance by the user, indicating whether the control device 104 switches to the three-dimensional display shown in FIG. 27B or to the three-dimensional display shown in FIG. 28B, is already in place in step S30.

Subsequently, the operation proceeds to step S40, in which the control device 104 detects any movement of the user's hand 2a by monitoring for any change in the three-dimensional position of the hand 2a, occurring from one set of image data to another set of image data among sets of image data input in time series from the three-dimensional position detecting camera 102. If no movement of the user's hand 2a is detected in step S40, the operation proceeds to step S60 to be described in detail later. If, on the other hand, a movement of the user's hand 2a is detected in step S40, the operation proceeds to step S50.

In step S50, the control device 104 further alters the visually perceived distance between the user and the reproduced image 2b along the depthwise direction. First, the processing executed in step S50 in conjunction with the three-dimensional display achieved by making the image 2b appear to jump forward, as shown in FIG. 27B is described. In this situation, upon detecting that the three-dimensional position of the user's hand 2a has moved closer to the 3-D monitor 106, the control device 104 increases the extent by which the image 2b appears to jump forward, as illustrated in FIG. 27C, by further reducing the visually perceived distance between the user and the reproduced image 2b along the depthwise direction relative to the state shown in FIG. 27B. As a result, the user, having moved his hand closer to the 3-D monitor 106, experiences a sensation of the image 2b being pulled even closer toward the hand.

If, on the other hand, the control device 104 detects that the three-dimensional position of the user's hand 2a has moved further away from the 3-D monitor 106, it reduces the extent to which the image 2b is made to appear to jump forward by increasing the visually perceived distance between the user and the reproduced image 2b along the depthwise direction relative to the state shown in FIG. 27B. As a result, the user experiences a sensation of the image 2b moving further away from his hand, which has moved away from the 3-D monitor 106. It is to be noted that the extent to which the image is made to appear to jump forward should be altered by ensuring that the distance between the hand 2a and the image 2b as visually perceived by the user remains constant at all times and that the image 2b maintains a natural stereoscopic appearance by keeping the largest extent to which the image is made to appear to jump forward to that equivalent to approximately 1° of binocular parallax.

Next, the processing executed in step S50 in conjunction with the three-dimensional display achieved by making the image 2b appear to sink inward, as shown in FIG. 28B is described. In this situation, upon detecting that the three-dimensional position of the user's hand 2a has moved closer to the 3-D monitor 106, the control device 104 increases the extent by which the image 2b appears to sink inward, as illustrated in FIG. 28C, by further increasing the visually perceived distance between the user and the reproduced image 2b along the depthwise direction relative to the state shown in FIG. 28B. As a result, the user, having moved his hand closer to the 3-D monitor 106, experiences a sensation of the image 2b being pushed further into the screen.

If, on the other hand, the control device 104 detects that the three-dimensional position of the user's hand 2a has moved further away from the 3-D monitor 106, it reduces the extent to which the image 2b is made to appear to sink inward by reducing the visually perceived distance between the user and the reproduced image 2b along the depthwise direction relative to the state shown in FIG. 27C. As a result, the user experiences a sensation of the image 2b sinking away from his hand to a lesser extent, as his hand has moved away from the 3-D monitor 106. It is to be noted that the extent to which the image is made to appear to sink inward should be altered by ensuring that the distance between the hand 2a and the image 2b as visually perceived by the user remains constant at all times and that the image 2b maintains a natural stereoscopic appearance by keeping the largest extent to which the image is made to appear to sink inward to that equivalent to approximately 1° of binocular parallax.

Subsequently, the operation proceeds to step S60, in which the control device 104 makes a decision as to whether or not the user has issued an instruction for ending the image reproduction. If a negative decision is made in step S60, the operation returns to step S20. However, if an affirmative decision is made in step S60, the processing ends.

The following advantages are achieved through the seventh embodiment described above.

(1) Upon detecting the three-dimensional position of the user's hand 2a in an image input from the three-dimensional position detecting camera 102, the control device 104 switches the display mode from the two-dimensional display to the three-dimensional display so as to display the image 2b, currently on display at the 3-D monitor 106, as with a three-dimensional effect by altering the visually perceived distance between the user and the reproduced image 2b along the depthwise direction. As a result, the user, holding his hand in front of the monitor 106, is able to experience a sensation of the image 2b being pulled toward the user's hand or a sensation of pushing the image 2b deeper into the screen. In addition, the control device 104 informs the user of the detection of the target object by altering the image along the direction of visually perceived depth, without compromising the viewability of the image.

(2) The control device 104 detects a movement of the user's hand 2a and further alters the visually perceived distance between the user and the reproduced image 2b along the depthwise direction. As a result, the user is able to adjust the extent to which the image 2b is made to appear to jump forward or sink inward in an intuitive manner with a simple gesture of his hand.

(3) The control device 104 alters the visually perceived distance between the user and the reproduced image 2b currently on display along the depthwise direction so as to allow the user to visually perceive that the distance between his hand 2a and the image 2b remains constant at all times. As a result, the user is able to feel that the extent to which the image is made to appear to jump forward or sink inward is altered by following his hand movement.

(4) The control device 104 switches from the two-dimensional display mode to the three-dimensional display mode by reducing the visually perceived distance between the user and the reproduced image 2b along the depthwise direction so as to make the image 2b appear to jump forward. Thus, the user is able to experience a sensation of the image 2b being pulled toward his hand held in front of the 3-D monitor 106.

(5) The control device 104 makes the image 2b appear to jump out to a position close to the user's hand 2a. The user thus experiences a visual sensation of almost touching the image 2b.

(6) The control device 104 switches from the two-dimensional display mode to the three-dimensional display mode by increasing the visually perceived distance between the user and the reproduced image 2b along the depthwise direction so as to make the image 2b appear to sink inward. Thus, the user is able to experience a sensation of his hand held in front of the 3-D monitor 106 pushing the image 2b deeper into the screen.

### Eighth Embodiment

In reference to drawings, the eighth embodiment of the present invention is described. The eighth embodiment is distinguishable from the seventh embodiment in the reproduction state adjustment processing executed for the image 2b and accordingly, the following detailed explanation focuses on the feature differentiating the eighth embodiment from the seventh embodiment. It is to be noted that features of the eighth embodiment other than the reproduction state adjustment processing executed for the image 2b are similar to those in the seventh embodiment and a repeated explanation thereof is not provided.

The control device 104 achieved in the eighth embodiment, having detected the three-dimensional position of the user's hand 2a, brings up a three-dimensional display of the image 2b by rendering the image 2b reproduced at the 3-D monitor 106 into a spherical shape and by adding visual depth to the image in correspondence to the newly assumed spherical shape.

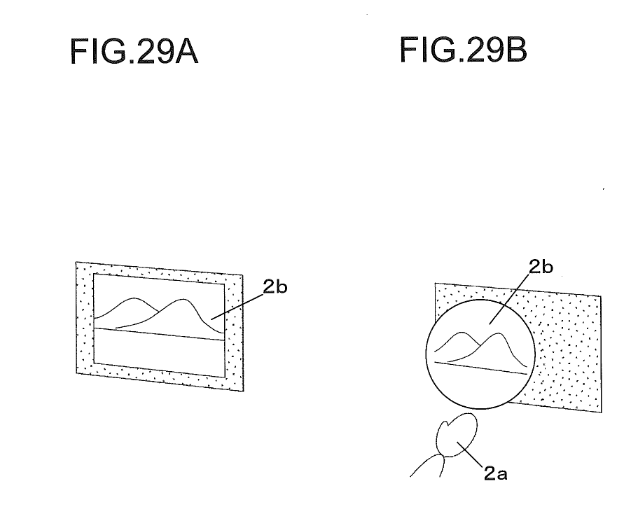

The control device 104 switches from the two-dimensional display mode shown in FIG. 29A to the three-dimensional display mode by, for instance, rendering the image 2b into a spherical shape appearing to jump forward from the screen, as shown in FIG. 29B. As a result, the user is able to experience a sensation of the image 2b being pulled toward his hand 2a held in front of the 3-D monitor 106.

As an alternative, the control device 104 may switch from the two-dimensional display mode to the three-dimensional display mode by rendering the image 2b into a spherical shape appearing to sink deeper into the screen. In this case, the user will be able to experience a sensation of his hand 2a held in front of the 3-D monitor 106, pushing the image 2b deeper into the screen.

It is to be noted that a setting, selected in advance by the user indicating whether the control device 104 is to switch to the three-dimensional display of the image appearing to jump forward or to the three-dimensional display of the image appearing to sink inward, is already in place.

Subsequently, upon detecting that the three-dimensional position of the user's hand 2a has moved closer to the 3-D monitor 106, the control device 104 increases the extent to which the image 2b is made to appear to jump forward or sink inward. Through these measures, the user is allowed to experience a sensation of the image 2b being pulled even closer to his hand 2a held closer to the 3-D monitor 106 or a sensation of the image 2b being pushed deeper into the screen by his hand 2a held closer to the 3-D monitor 106.

If, on the other hand, the control device 104 detects that the three-dimensional position of the user's hand 2a has moved further away from the 3-D monitor 106, it reduces the extent to which the image 2b is made to appear to jump forward or sink inward. As a result, the user is able to experience a sensation of the image 2b being pulled toward his hand 2a, having moved further away from the 3-D monitor 106, to a lesser extent or a sensation of his hand 2a, held further away from the 3-D monitor 106, pushing the image 2b to a lesser extent.

The following advantages are achieved through the eighth embodiment described above.

(1) The digital photo frame 100, equipped with a control device 104 that detects the user's hand 2a and a control device 104 that displays the image 2b with a three-dimensional effect when the control device 104 detects the user's hand 2a, informs the user of detection of his hand 2a by bringing up the three-dimensional display of the image 2b without compromising the viewability of the image 2b.

(2) Upon detecting the user's hand 2a, the control device 104 in the digital photo frame 100 described in (1) above switches to the three-dimensional display by altering the shape of the image 2b and rendering visual depth to the image in correspondence to the newly assumed shape. Thus, the user is even more easily able to intuit that his hand 2a has been detected.

### Ninth Embodiment

In reference to drawings, the ninth embodiment of the present invention is described. The ninth embodiment is distinguishable from the seventh embodiment in the reproduction state adjustment processing executed for the image 2b and accordingly, the following detailed explanation focuses on the feature differentiating the ninth embodiment from the seventh embodiment. It is to be noted that features of the ninth embodiment other than the reproduction state adjustment processing executed for the image 2b are similar to those in the seventh embodiment and a repeated explanation thereof is not provided.

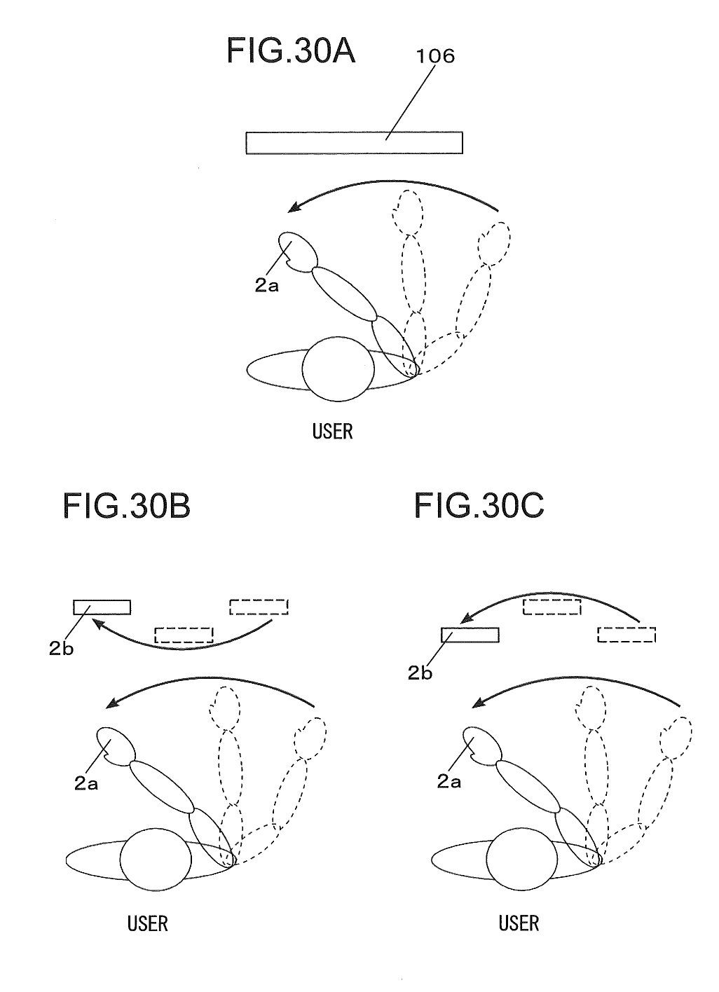

When the user moves his hand 2a sideways, the hand 2a moves in a circular arc formed with the fulcrum thereof assumed at, for instance, his shoulder, so as to approach and move away from the 3-D monitor 106 along the depth thereof, as shown in FIG. 30A. Accordingly, the image 2b is displayed in the ninth embodiment so as to appear to move in a circular arc by assuming different positions along the depthwise direction, as the hand 2a moves in the lateral direction.

The control device 104, having detected the three-dimensional position of the user's hand 2a, switches from the two-dimensional display mode to the three-dimensional display mode so as to make the image 2b appear to, for instance, jump forward from the screen by altering the visually perceived distance between the user and the reproduced image 2b along the depthwise direction (front-back direction).

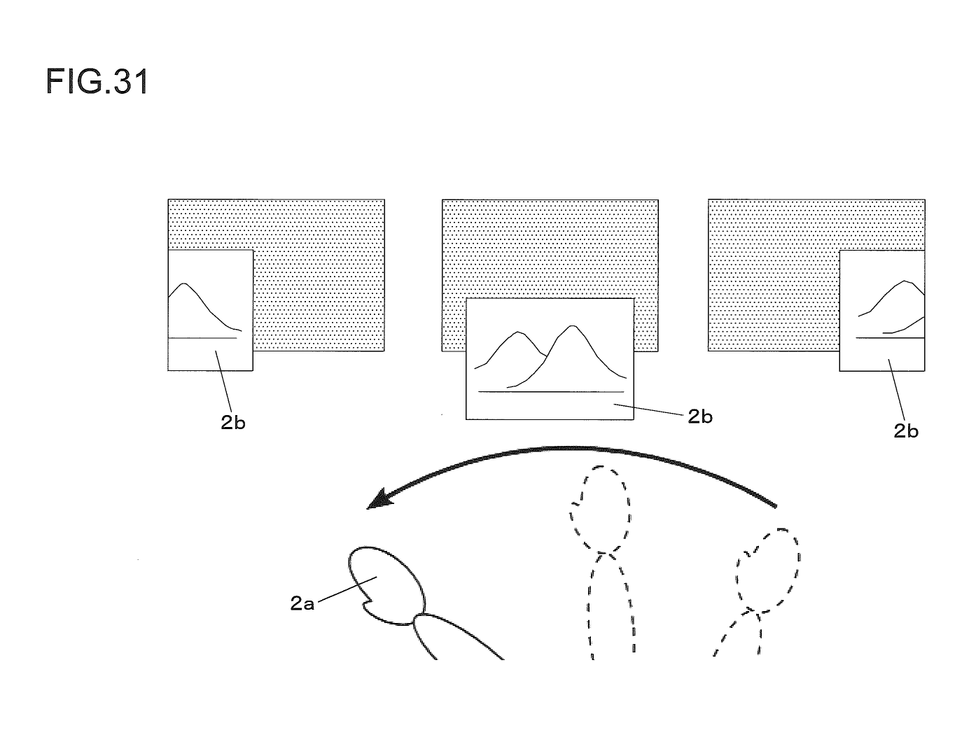

Subsequently, the control device 104, having detected that the three-dimensional position of the hand 2a has moved sideways, moves the image 2b along the direction in which the hand 2a has moved and also reduces the extent to which the image 2b is made to appear to jump forward as the image 2b approaches the left end or the right end of the screen but increases the extent to which the image 2b is made to appear to jump forward as the image 2b approaches the center of the screen, as illustrated in FIGS. 30B and 31. Namely, it displays the image 2b so that the image 2b appears to move closer to the hand 2a held closer to the 3-D monitor 106 and that the image 2b appears to move away from the hand 2a held further away from the 3-D monitor 106. As a result, the user is able to experience a sensation of the image 2b, moving by interlocking with the movement of his hand 2a, pulling it forward.

As an alternative, the control device 104, having detected the three-dimensional position of the user's hand 2a, may switch from the two-dimensional display mode to the three-dimensional display mode so as to make the image 2b appear to sink deeper into the screen by altering the visually perceived distance between the user and the reproduced image 2b along the depthwise direction (front-back direction).

In this case, the control device 104, having detected that the three-dimensional position of the hand 2a has moved sideways, moves the image 2b along the direction in which the hand 2a has moved and also reduces the extent to which the image 2b is made to appear to sink inward as the image 2b approaches the left end or the right end of the screen but increases the extent to which the image 2b is made to appear to sink inward as the image 2b approaches the center of the screen, as illustrated in FIG. 30C. Namely, it displays the image 2b so that the image 2b appears to move further away from the hand 2a held closer to the 3-D monitor 106 and that the image 2b appears to move closer to the hand 2a held further away from the 3-D monitor 106. As a result, the user is able to experience a sensation of the image 2b, moving by interlocking with the movement of his hand 2a, pushing it into the screen.

The following advantages are achieved through the ninth embodiment described above.

(1) The digital photo frame 100, equipped with a control device 104 that detects the user's hand 2a and a control device 104 that displays the image 2b with a three-dimensional effect when the control device 104 detects the user's hand 2a, informs the user of detection of his hand 2a by bringing up the three-dimensional display of the image 2b without compromising the viewability of the image 2b.

(2) The digital photo frame 100 described in (1) above further includes a control device 104 that detects a movement of the user's hand 2a and the control device 104, upon detecting a movement of the user's hand 2a, alters the visually perceived distance between the user's hand 2a and the image 2b along the front-back direction in correspondence to the movement of the user's hand 2a, thereby enabling the user to issue an instruction for manipulating the image 2b in an intuitive manner with a simple gesture of his hand 2a.

(3) The control device 104 in the digital photo frame 100 described in (2) above moves the image 2a by altering the visually perceived distance between the user's hand 2a and the image 2b along the front-back direction in correspondence to the movement of the user's hand 2a, which allows the user to intuit with ease that the image 2b can be manipulated by interlocking with the movement of his hand 2a.

### Tenth Embodiment

In reference to drawings, the tenth embodiment of the present invention is described. The image display apparatus achieved in the tenth embodiment is configured so as to display a video image in a two-dimensional display with operation icons, used to manipulate the video image, brought up in a three-dimensional display. It is to be noted that since the image display apparatus achieved in the tenth embodiment assumes a structure similar to that in the seventh embodiment having been described in reference to FIG. 24, a repeated explanation is not provided.

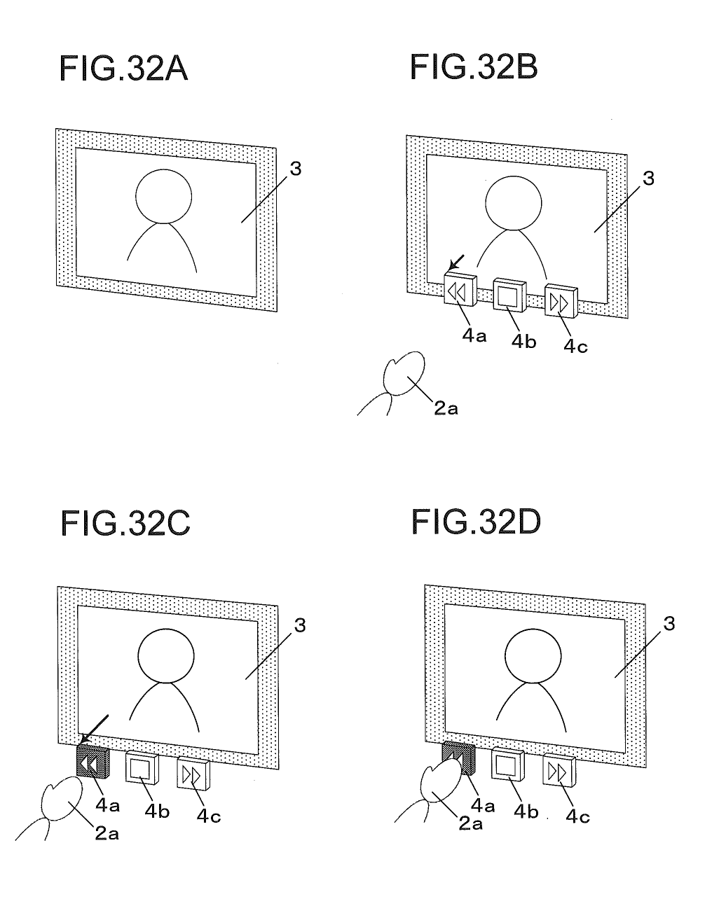

The control device 104 achieved in the tenth embodiment brings up a two-dimensional display of a video image 3 at the 3-D monitor 106, as shown in FIG. 32A and also photographs an image with the three-dimensional position detecting camera 102.

Then, upon detecting the three-dimensional position of the user's hand 2a based upon the image data input from the three-dimensional position detecting camera 102, the control device 104 brings up a three-dimensional display of operation icons 4a to 4c at the 3-D monitor 106 by making them appear to jump forward from the screen, as shown in FIG. 32B. The operation icon 4a may correspond to, for instance, a video image rewind operation, the operation icons 4b may correspond to a video image pause operation and the operation icons 4c may correspond to a video image fast-forward operation. The user, holding his hand 2a in front of the 3-D monitor 106, is thus able to experience a sensation of the operation icons 4a to 4c being pulled toward his hand away.

Subsequently, the control device 104, having detected that the three-dimensional position of the hand 2a has moved closer to the 3-D monitor 106, reduces the visually perceived distance between the hand 2a and the operation icons 4a to 4c along the depthwise direction, as shown in FIG. 32C so as to increase the extent to which the operation icons 4a to 4c are made to appear to jump forward, relative to the state shown in FIG. 32B. As a result, the user is able to experience a sensation of the operation icons 4a to 4c being pulled even closer to his hand 2a having moved closer to the 3-D monitor 106.

In addition, the control device 104 displays the operation icon present at a position corresponding to the three-dimensional position of the hand 2a (i.e., the operation icon displayed at the position closest to the three-dimensional position of the hand 2a) in a color different from the display color used for the other operation icons 4b and 4c so as to highlight the operation icon 4a on display. Through these measures, the user is informed that the operation icon 4a is the operation candidate icon.

Furthermore, upon detecting that the three-dimensional position of the hand 2a has moved even closer to the 3-D monitor 106 and that the distance between the hand 2a and the 3-D monitor 106 is now equal to or less than a predetermined value (e.g., 5 cm) as shown in FIG. 32D, the control device 104 executes the processing corresponding to the highlighted operation icon 4a (rewind operation for the video image 3 in this example). As a result, the user is able to experience a sensation of the hand 2a virtually touching the operation icon 4a to issue an instruction for executing the processing corresponding to the particular operation icon 4a.

If, on the other hand, the control device 104 detects that the three-dimensional position of the hand 2a has moved further away from the 3-D monitor 106, it increases the visually perceived distance between the hand 2a and the operation icons 4a to 4c along the depthwise direction so as to reduce the extent to which the operation icons 4a to 4c are made to appear to jump forward. Thus, the user is able to experience a sensation of the operation icons 4a to 4c moving away from his hand 2a held further away from the 3-D monitor 106.

The following advantages are achieved through the tenth embodiment described above.

(1) The digital photo frame 100, equipped with a control device 104 that detects the user's hand 2a and a control device 104 that brings up a three-dimensional display of the operation icons 4a to 4c when the control device 104 detects the user's hand 2a, informs the user of detection of his hand 2a by bringing up the three-dimensional display of the operation icons 4a to 4c without compromising the viewability of the operation icons 4a to 4c.

(2) The digital photo frame 100 described in (1) above further includes a control device 104 that detects a movement of the user's hand 2a and the control device 104, upon detecting a movement of the user's hand 2a, alters the visually perceived distance between the user's hand 2a and the operation icons 4a to 4c along the front-back direction in correspondence to the movement of the user's hand 2a, thereby enabling the user to issue an instruction for operating the operation icons 4a to 4c in an intuitive manner with a simple gesture of his hand 2a.

(3) The control device 104 in the digital photo frame 100 described in (2) above executes the processing corresponding to the operation icon 4a upon detecting that the user's hand 20 has moved even closer to the 3-D monitor 106 and the distance between the user's hand 2a and the 3-D monitor 106 is now equal to or less than a predetermined value. Thus, the user is able to issue an instruction for execution of the processing corresponding to the particular operation icon 4a in an intuitive manner with a simple gesture of his hand 2a.

### Eleventh Embodiment

In reference to drawings, the eleventh embodiment of the present invention is described. The eleventh embodiment is distinguishable from the seventh embodiment in the reproduction state adjustment processing executed for the image 2b and accordingly, the following detailed explanation focuses on the feature differentiating the eleventh embodiment from the seventh embodiment. It is to be noted that features of the eleventh embodiment other than the reproduction state adjustment processing executed for the image 2b are similar to those in the seventh embodiment and a repeated explanation thereof is not provided.

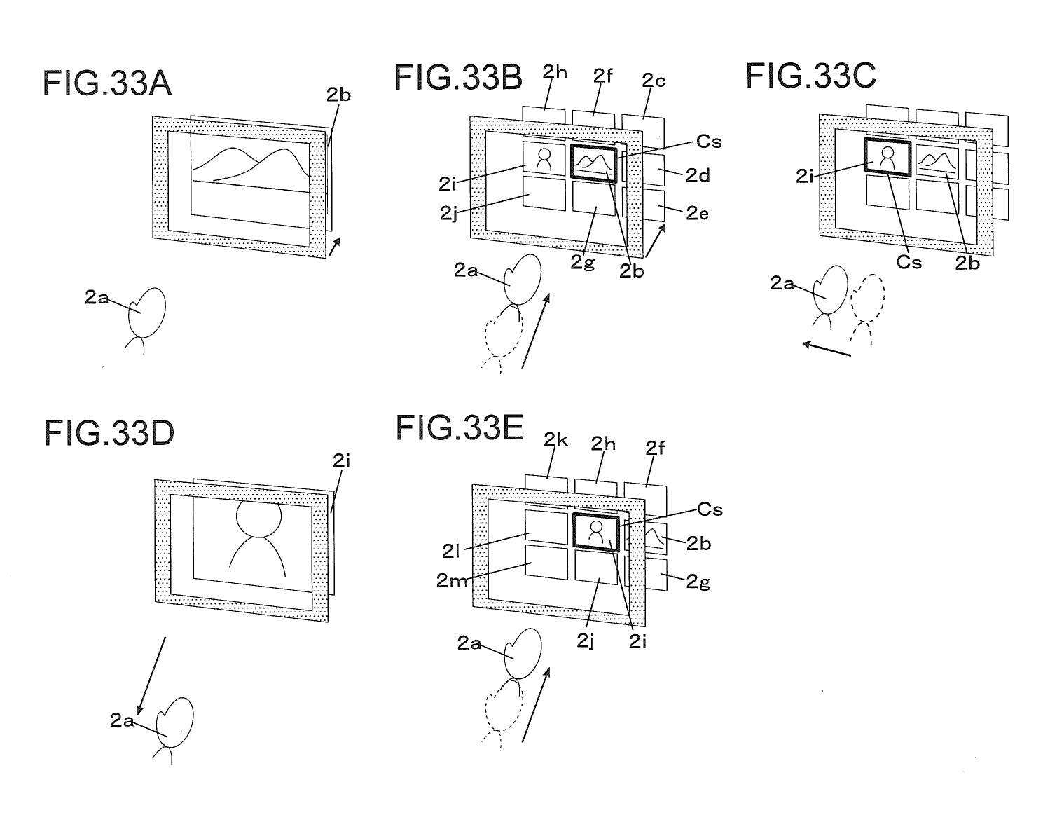

The control device 104 achieved in the eleventh embodiment, having detected the three-dimensional position of the user's hand 2a, brings up a three-dimensional display of the reproduced image 2b appearing to sink deeper into the screen, as shown in FIG. 33A, by increasing the visually perceived distance between the user and the reproduced image 2b along the depthwise direction.

Subsequently, upon detecting that the three-dimensional position of the hand 2a has moved closer to the 3-D monitor 106, the control device 104 gradually reduces the size of the image 2b on display and also displays a plurality of images (2c through 2j) preceding and following the image 2b in a reduced size around the image 2b, as shown in FIG. 33B. In other words, a thumbnail display of the images 2b through 2j, arranged in a grid pattern (e.g., a 3×3 grid pattern) is brought up at the 3-D monitor 106. It is to be noted that the term “thumbnail display” is used to refer to a display mode in which reduced images referred to as thumbnails are displayed side-by-side. In addition, the control device 104 adjusts the three-dimensional display of the thumbnail images 2b to 2j by increasing the extent to which they appear to sink inward relative to the state shown in FIG. 33A.

In addition, the control device 104 displays a cursor Cs as a rectangular frame set around the image 2b. The cursor Cs is used to select a specific thumbnail image.

Subsequently, upon detecting that the hand 2a has moved up, down, to the left or to the right, the control device 104 moves the cursor Cs along the direction in which the hand 2a has moved. For instance, if the hand 2a in the state shown in FIG. 33B moves to the left, the cursor Cs is moved to the image 2i directly to the left of the image 2b, as shown in FIG. 33C.

If the control device 104 detects, in this state, that the hand 2a has moved further away from the 3-D monitor 106, it brings up an enlarged display of the image 2i alone, selected with the cursor Cs at the time point at which the retreating hand 2a has been detected, as shown in FIG. 33D. At this time, the control device 104 brings up a three-dimensional display of the enlarged image 2i by reducing the extent to which it appears to sink inward relative to the state shown in FIG. 33C.

Subsequently, upon detecting that the hand 2a has again moved closer to the 3-D monitor 106, the control device 104 gradually reduces the size of the image 2i on display and also displays a plurality of images (2b, 2f through 2h, 2j through 2m) preceding and following the image 2i in a reduced size around the image 2i, as shown in FIG. 33E. At this time, the control device 104 brings up the thumbnail images (2b, 2f to 2m) with a three-dimensional effect so that they appear to sink further inward relative to the state shown in FIG. 33D.

In this state, if the control device 104 detects that the hand 2a has moved sideways by a significant extent, equal to or greater than a predetermined threshold value, the control device 104 slides the nine images (2b, 2f through 2m) currently on thumbnail display together along the direction in which the hand 2a has moved and also slides the preceding or following group of nine images so as to bring them up on display. At this time, the control device 104 brings up the new batch of thumbnail images with a three-dimensional effect appearing to sink inward as well. It is to be noted that if the extent to which the hand 2a has moved sideways is less than the predetermined threshold value, the control device 104 moves the cursor Cs along the direction in which the hand 2a has moved, as explained earlier.

Furthermore, if the control device 104 detects, in the state shown in FIG. 33D, that the hand 2a has moved further away from the monitor 106, it resumes the two-dimensional display mode so as to display the image 2i as a two-dimensional display.

As described above, the control device 104 switches to the thumbnail display as the hand 2a moves closer to the 3-D monitor 106. As a result, the user is able to issue a thumbnail display instruction in an intuitive manner with a simple gesture of his hand 2a as if to push the image into the screen.

Subsequently, upon detecting that the hand 2a has moved up, down, to the left or to the right while the thumbnail display is up, the control device 104 moves the cursor Cs along the direction in which the hand 2a has moved, whereas upon detecting that the hand 2a has moved sideways to a significant extent, the control device 104 switches to the thumbnail display to bring up another batch of thumbnail images by sliding the current thumbnail images sideways. As a result, the user is able to issue an instruction for moving the cursor Cs or switching the thumbnail images in an intuitive manner with a simple gesture of his hand 2a.

In addition, if the hand 2a moves further away from the monitor 106 while the thumbnail display is up, the control device 104 enlarges the image selected with the cursor Cs. The control device 104 thus allows the user to issue an instruction for image enlargement in an intuitive manner with a simple gesture of his hand 2a as if to pull the image forward.

The following advantages are achieved through the eleventh embodiment described above.

(1) The digital photo frame 100, equipped with a control device 104 that detects the user's hand 2a and a control device 104 that displays the image 2b with a three-dimensional effect when the control device 104 detects the user's hand 2a, informs the user of detection of his hand 2a by bringing up the three-dimensional display of the image 2b without compromising the viewability of the image 2b.

(2) The digital photo frame 100 described in (1) above further includes a control device 104 that detects a movement of the user's hand 2a and the control device 104, upon detecting a movement of the user's hand 2a, alters the visually perceived distance between the user's hand 2a and the image 2b along the front-back direction in correspondence to the movement of the user's hand 2a, thereby enabling the user to issue an instruction for manipulating the image 2b in an intuitive manner with a simple gesture of his hand 2a.

(3) The control device 104 in the digital photo frame 100 described in (2) brings up a three-dimensional display of a plurality of images 2b to 2j, including the image 2b, in a reduced size upon detecting that the user's hand 2a has moved closer to the 3-D monitor 106. As a result, the user is able to issue a reduced display instruction for the image 2b in an intuitive manner with a simple gesture of his hand 2a.

(Variations)

It is to be noted that the cameras achieved in the seventh through eleventh embodiments described above allow for the following variations.

(1) The digital photo frame 100 achieved in each of the embodiments described above includes a storage medium 105 constituted with a nonvolatile memory such as a flash memory and the reproduction target image data are recorded into this storage medium 105. However, the digital photo frame 100 may adopt an alternative structure that includes a memory card slot and image data recorded in a memory card being loaded in the memory card slot, instead of image data recorded in the storage medium 105, may be designated as a reproduction target.

(2) The control device 104 achieved in the embodiments described earlier alters the extent to which the image 2b is made to appear to jump forward or the extent to which the image 2b is made to appear to sink into the screen depending upon whether the three-dimensional position of the user's hand 2a moves closer to or further away from the 3-D monitor 106, as illustrated in FIGS. 27A, 27B and 27C and FIGS. 28A, 28B and 28C. As an alternative, the control device 104 may alter the extent to which the image 2b is made to appear to jump forward or the extent to which the image 2b is made to appear to sink into the screen in correspondence to the length of time over which the user holds his hand 2a in front of the monitor. For instance, the control device 104, displaying the reproduced image 2b by adopting the method illustrated in FIGS. 27A, 27B and 27C, may gradually increase the extent to which the reproduced image 2b is made to appear to jump forward as a greater length of time elapses following the detection of the user's hand 2a. In this case, the user will be able to experience a sensation of the image 2b being pulled closer to his hand as he holds the hand in front of the 3-D monitor 106 longer. As an alternative, the control device 104, displaying the reproduced image 2b by adopting the method illustrated in FIGS. 28A, 28B and 28C, may gradually increase the extent to which the reproduced image 2b is made to appear to sink inward as a greater length of time elapses following the detection of the user's hand 2a. In this case, the user will be able to experience a sensation of the image 2b being pushed into the screen, further away from his hand as he holds the hand in front of the 3-D monitor 106 longer.

(3) In an embodiment described above, a specific setting indicating whether the control device 104 is to switch to a three-dimensional display such as that shown in FIG. 27B or to a three-dimensional display such as that shown in FIG. 28B in step S30, will have been selected in advance by the user and thus will have been in place. Instead, the control device 104 may sustain the two-dimensional display of the image 2b when it detects the three-dimensional position of the user's hand 2a and later, upon detecting that the user's hand 2a has moved further away from the 3-D monitor 106 subsequently, it may bring up the three-dimensional display of the image 2b shown in FIG. 27B by making the image 2b appear to jump forward. If, on the other hand, it detects that the user's hand 2a has moved closer to the 3-D monitor 106, it may bring up the three-dimensional display shown in FIG. 28B by making the image 2b appear to sink deeper into the screen. In this case, the user will be able to experience a sensation of the image 2b being pulled toward his hand held further away from the 3-D monitor 106 and also a sensation of the image 2b being pushed deeper into the screen by his hand held closer to the 3-D monitor 106.

As a further alternative, the control device 104 may select either the three-dimensional display method shown in FIG. 27B or the three-dimensional display method shown in FIG. 28B depending upon the type of reproduced image 2b that is currently on display. For instance, if the reproduced image 2b is a landscape, the control device may switch to the three-dimensional display method shown in FIG. 28B upon detecting the three-dimensional position of the user's hand 2a, whereas if the reproduced image 2b is an image other than a landscape, the control device may switch to the three-dimensional position of the three-dimensional display method shown in FIG. 27B upon detecting the user's hand 2a. Through these measures, the user viewing a reproduced image of a landscape located away from the user is allowed to experience a sensation of the image 2b on display sinking further away from the user.

(4) The embodiments have been described by assuming that a single three-dimensional position of the user's hand 2a belonging to a given user is detected in an image obtained by the three-dimensional position detecting camera 102. However, it is conceivable that a plurality of hands may be detected and thus, a plurality of three-dimensional positions may be detected. In such a case, the control device 104 should execute the processing described above in conjunction with a selected target hand. For instance, the control device 104 may designate the hand present at the position closest to the center of the image as the target hand or may designate the hand taking up the largest area within the image as the target hand. As an alternative, the control device 104 may designate the hand that is detected first as the target hand.

(5) The embodiments have been each described by assuming that the three-dimensional position detecting camera 102, disposed on the front side of the digital photo frame 100, photographs the user facing the digital photo frame 100, as shown in FIG. 25. However, the position of the user assumed relative to the three-dimensional position detecting camera 102 is bound to vary, and the user may stand at a position at which the user's hand 2a remains outside the angular field of view of the three-dimensional position detecting camera 102. In order to address this issue, the three-dimensional position detecting camera 102 may adopt a swivel structure that will allow the three-dimensional position detecting camera 102 to seek an optimal camera orientation at which it is able to detect the user's hand 2a. As an alternative, the user may be informed that his hand 2a is outside the angular field of view of the three-dimensional position detecting camera 102 and be prompted to move into the angular field of view of the three-dimensional position detecting camera 102. In this case, the user may be alerted by a sound output through a speaker (not shown) or with a message displayed on the 3-D monitor 106. Then, as the user's hand 2a moves into the three-dimensional position detection range, a sound or a message may be output again or the image 2b on display may be framed for emphasis so as to inform the user that the three-dimensional position of the hand 2a can now be detected.

(6) The control device 104 achieved in the various embodiments described above switches to a display of the image 2b with a three-dimensional effect upon detecting the three-dimensional position of the user's hand 2a. Instead, the control device 104 may bring up a three-dimensional display of the image 2b upon detecting the three-dimensional position of a target object other than the user's hand 2a. For instance, the user may hold a pointer in front of the 3-D monitor 106 and, in such a case, the control device 104 may display the image 2b with a three-dimensional effect upon detecting the pointer as the detection target object.

(7) The control device 104 achieved in the various embodiments described above alters the extent to which the image 2b is made to appear to jump forward or sink deeper into the screen upon detecting displacement of the three-dimensional position of the user's hand 2a along the direction perpendicular to the 3-D monitor 106, i.e., upon detecting that the three-dimensional position of the hand 2a has moved closer to or further away from the 3-D monitor 106. As an alternative, the control device 104, having detected that the three-dimensional position of the user's hand 2a has moved along the horizontal direction relative to the 3-D monitor 106, i.e., upon detecting that the user's hand 2a has moved sideways relative to the 3-D monitor 106, may move the reproduced image 2b on display to the left or to the right in conformance to the movement of the user's hand 2a. In this case, the user will be able to issue an instruction for moving the image 2b in an intuitive manner with a simple gesture of his hand. As a further alternative, the control device 104 may enlarge or reduce the reproduced image 2b currently on display or may switch from the current reproduced image to another image for display, as the user's hand 2a moves sideways.

(8) The control device 104 achieved in the various embodiments described above provides the two-dimensional display of the image 2b at the reproduction start and then switches to the three-dimensional display with the timing with which the user's hand 2a is detected. However, assuming that the reproduction target image 2b is a three-dimensional image to begin with, the control device 104 may bring up a three-dimensional display in the first place. Furthermore, even when the reproduction target image 2b is a two-dimensional image, the control device 104 may display it with a three-dimensional effect at the start of reproduction.

(9) The cameras achieved in the embodiments described above are each constituted with the-three-dimensional position detecting camera 102. However, the invention is not limited to this example and it may be adopted in conjunction with a regular camera that is not capable of detecting the three-dimensional position of a subject. In such a case, the control device 104 should make an affirmative decision in step S20 in FIG. 26 upon detecting the user's hand 2a in an image captured with the camera. In addition, the control device 104 should detect a movement of the user's hand 2a by monitoring for any change in the position or the size of the hand 2a, occurring from one image to another, based upon the image data input from the camera in time series.

(10) The image display apparatus according to the present invention is embodied as a digital photo frame in the description provided above. However, the present invention is not limited to this example and it may instead be adopted in another apparatus, such as a digital camera or a portable telephone that is equipped with a three-dimensional position detecting camera and a 3-D monitor and has an image reproduction function. Furthermore, the present invention may be equally effectively adopted in a television set or a projector apparatus used to project images.

(11) In the eighth embodiment described earlier, the image 2b is altered so as to gradually take on a spherical shape. However, the present invention is not limited to this example and the image may be altered to assume a polygonal shape or a cylindrical shape, as long as the image 2b is altered into a shape with a projecting plane or a recessed plane with which spatial depth can be expressed.

(12) In the tenth embodiment described earlier, the operation icons 4a to 4c used to manipulate video images that are displayed with a three-dimensional effect. However, the present invention is not limited to this example and alternative images may be brought up in a three-dimensional display as described below.

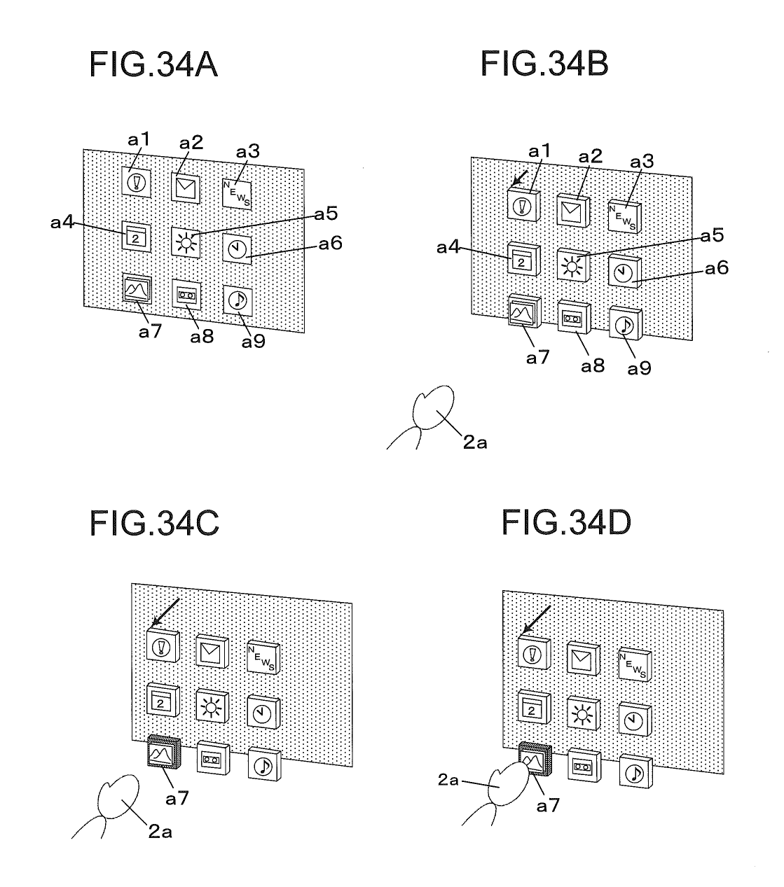

For instance, the control device 104 achieved in variation 12 brings up a two-dimensional display of icons (hereafter referred to as application icons) a1 to a9, each to be used to issue an application program startup instruction for starting up a specific application program (hereafter may be otherwise referred to as an app in the following description), by arranging them in a grid pattern at the 3-D monitor 106, as shown in FIG. 34A, as power is turned on. The application icon a7 may correspond to a still image reproduction app, whereas the application icon a8 may correspond to a video image reproduction app.

Upon detecting the three-dimensional position of the user's hand 2a, the control device 104 switches to a three-dimensional display at the 3-D monitor 106 by making the application icons a1 to a9 appear to jump forward, as shown in FIG. 34B.

Subsequently, the control device 104, having detected that the three-dimensional position of the hand 2a has moved closer to the 3-D monitor 106, increases the extent to which the application icons a1 to a9 are made to appear to jump forward, as shown in FIG. 34C, by reducing the visually perceived distance between the hand 2a and the application icons a1 to a9 along the depthwise direction relative to the state shown in FIG. 34B.

In addition, the control device 104 displays the application icon a7 present at a position corresponding to the three-dimensional position of the hand 2a in a color different from the display color used for the other application icons a1 to a6, a8 and a9 so as to highlight the application icon a7 on display. Through these measures, the user is informed that the application icon a7 is the operation candidate icon.

Furthermore, upon detecting that the three-dimensional position of the hand 2a has moved even closer to the 3-D monitor 106 and that the distance between the hand 2a and the 3-D monitor 106 is now equal to or less than a predetermined value (e.g., 5 cm) as shown in FIG. 34D, the control device 104 starts up the app (the still image reproduction app in this example) corresponding to the highlighted application icon a7.

(13) In the tenth embodiment described earlier, the operation icon 4a present at a position corresponding to the three-dimensional position of the hand 2a is highlighted in the display by using a different display color. However, the operation icon 4a may be highlighted by adopting a method other than this. For instance, the operation icon 4a may be highlighted in the display by enclosing it in a frame, by displaying it in a size greater than the other operation icons, by raising its luminance or by making it appear to jump forward by a greater extent than the other operation icons.

(14) It is to be noted that while the image is manipulated in conformance to a hand movement in the embodiments described above, the image may be manipulated in response to a finger gesture in addition to the hand movement. For instance, upon detecting that the fingers, having been clenched together in a fist, have opened out, the image currently on display may be enlarged, whereas upon detecting that the hand, having been in the open palm state, has closed into a fist, the image on display may be reduced. In addition, a video image may be controlled in correspondence to the number of fingers held up in front of the monitor by, for instance, playing back a video at regular speed if the user holds up one finger, playing back the video at double speed if the user holds up two fingers and playing back the video at quadruple speed if the user holds up three fingers. Through these measures, a greater variation of image operations can be enabled.

In addition, while the image is manipulated in response to a hand movement in the embodiments described earlier, the image may be manipulated in a similar manner in response to a head movement instead of a hand movement. In this case, even when user's hands are busy operating a keyboard or a mouse to operate a personal computer and cannot, therefore, issue instructions for image operations through hand movements, he will be able to manipulate the image by moving his head.

It is to be noted that while the image is manipulated in response to a hand movement in the embodiments described above, the image may instead be manipulated in response to a movement of an object (such as pen) held in the user's hand.

As long as the features characterizing the present invention are not compromised, the present invention is not limited in any way whatsoever to the particulars of the embodiments described above. An addition, a plurality of the embodiments described above may be adopted in combination or any of the embodiments described above may be adopted in conjunction with a plurality of variations.

### Twelfth Embodiment

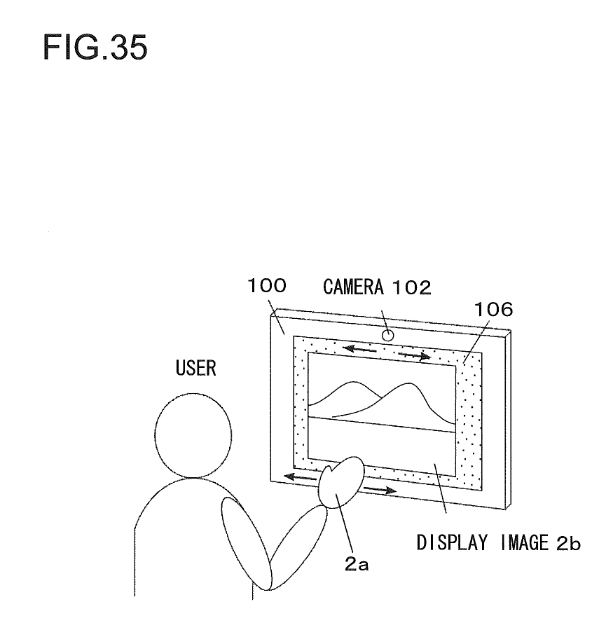

In reference to drawings, the twelfth embodiment of the present invention is described. FIG. 1, in reference to which the first embodiment has been described, should also be referred to as a block diagram presenting an example of a structure that may be adopted in the image display apparatus achieved in the twelfth embodiment. The image display apparatus may be embodied as, for instance, a digital photo frame 100 such as that shown in FIG. 35. The digital photo frame 100 comprises an operation member 101, a camera 102, a connection I/F (interface) 103, a control device 104, a storage medium 105 and a monitor 106. The operation member 101 includes various operation buttons and the like operated by the user of the digital photo frame 100.

The camera 102 is equipped with an image sensor such as a CCD image sensor or a CMOS image sensor. With the camera 102, which is disposed on the front side of the digital photo frame 100, as shown in FIG. 35, the image of the user facing the digital photo frame 100 can be captured. Image signals output from the image sensor in the camera 102 are output to the control device 104, which then generates image data based upon the image signals.

The connection I/F 103 is an interface via which the digital photo frame 100 establishes a connection with an external device. The digital photo frame 100 in the embodiment is connected with an external device with image data recorded therein, such as a digital camera, via the connection I/F 103. The control device 104 takes in image data from the external device via the connection I/F 103 and records the image data thus taken in into the storage medium 105.

It is to be noted that the connection I/F 103 may be a USB interface via which a wired connection between the external device and the digital photo frame 100 is established, a wireless LAN module via which the external device and the digital photo frame 100 can be connected with each other wirelessly, or the like. As an alternative, the image display apparatus may include a memory card slot instead of the connection I/F 103, and in such a case, image data can be taken into the image display apparatus as a memory card with image data recorded therein is loaded in the memory card slot.

The control device 104, constituted with a CPU, a memory and other peripheral circuits, executes overall control for the digital photo frame 100. It is to be noted that the memory constituting part of the control device 104 is a volatile memory such as an SDRAM. This memory includes a work memory where a program is opened when the CPU executes the program and a buffer memory where data are temporarily recorded.

In the storage medium 105, which is a nonvolatile memory such as a flash memory, a program executed by the control device 104, image data having been taken in via the connection I/F 103, and the like are recorded. At the monitor 106, which may be constituted with, for instance, a 3-D liquid crystal panel in the twelfth embodiment, a reproduction target image 2b is displayed as shown in FIG. 35. More specifically, the monitor 106 includes a parallax barrier (not shown) installed at the display surface thereof so as to display a plurality of images with varying parallaxes toward respective viewpoints (so as to provide a multi-viewpoint display). As a result, the user is able to view a 3-D image displayed with a stereoscopic effect.

The control device 104 displays the reproduction target image 2b at the monitor 106 by setting long portions obtained by slicing the two (or more) parallax images along the top/bottom direction, in an alternating pattern. The pitch of the parallax barrier is set to match the pitch with which the portions of the parallax images are arranged in the alternating pattern and the width of the openings at the parallax barrier matches the width of the parallax image portions. A user, viewing this display image from a point set apart by a specific distance, is able to view the individual images by separating them from one another with his left and right eyes, and thus, a binocular parallax phenomenon occurs. Since display technologies that may be adopted to provide such a stereoscopic display are of the known art, a detailed explanation is not provided.

The control device 104 also detects a movement of the user's hand 2a based upon the image captured with the camera 102, and upon detecting that the user's hand 2a has moved sideways, it switches the reproduced image 2b to another image in correspondence to the movement of the user's hand 2a, as illustrated in FIG. 35. For instance, upon detecting that the user's hand 2a has moved to the left, the control device 104 slides the reproduced image 2b currently on display to the left and displays the image immediately following the image 2b by also sliding the following image to the left. If, on the other hand, the control device 104 detects that the user's hand 2a has moved to the right, it slides the reproduced image 2b currently on display to the right and displays the image immediately preceding the image 2b by also sliding the preceding image to the right. Thus, the user is able to issue a display image switching instruction in an intuitive manner with a simple gesture of his hand.

In the twelfth embodiment, the reproduced image 2b is displayed by adopting an alternative display mode for an area surrounding the area of the image 2b that is blocked by the user's hand 2a in the viewer's eye. The following is a description of the display control processing executed by the control device 104 in correspondence to a movement of the user's hand 2a.

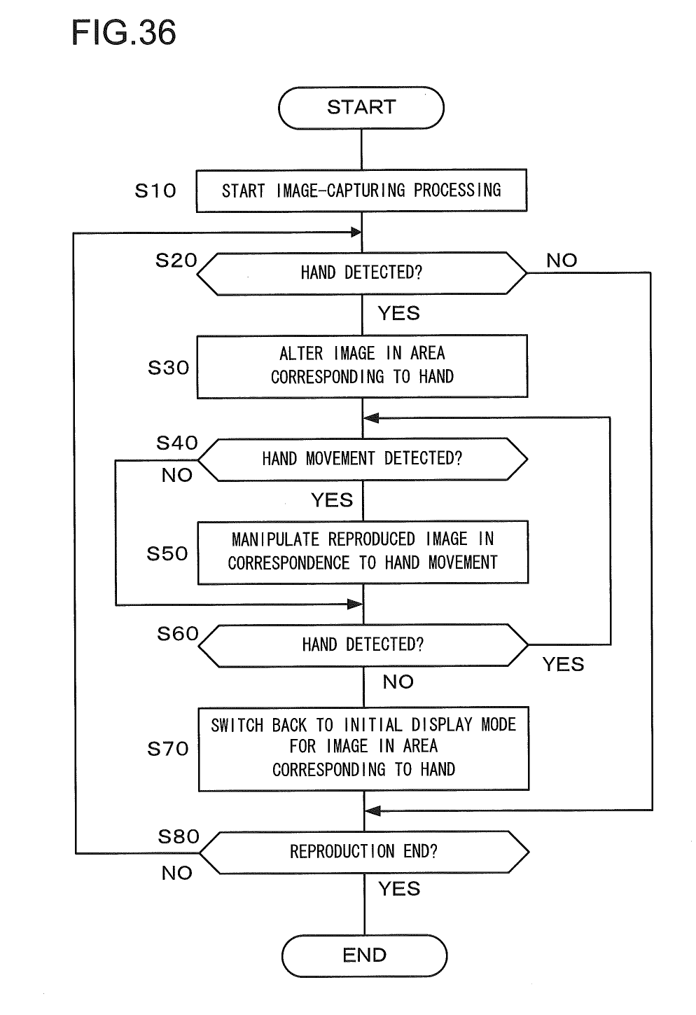

FIG. 36 presents a flowchart of the display control processing executed in response to a movement of the user's hand 2a. The processing in FIG. 36 is executed by the control device 104 as a program that is started up as the display of the reproduced image 2b starts at the monitor 106. It is to be noted that the monitor 106 is configured so as to display parallax images optimal for viewing from a point set apart from the monitor 106 by, for instance, 50 cm to 1 m.

In step S10 in FIG. 36, the control device 104 starts capturing images via the camera 102. The camera 102 in the twelfth embodiment is engaged in image capturing at a predetermined frame rate (e.g., 30 frames/sec) and thus, image data are successively input to the control device 104 from the camera 102 over predetermined time intervals corresponding to the frame rate. Upon starting the image capturing operation, the control device 104 proceeds to step S20.

In step S20, the control device 104 makes a decision based upon the image data input from the camera 102, as to whether or not the user's hand 2a is included in an input image. For instance, an image of the user's hand 2a may be recorded in advance as a template image, and, in such a case, the control device 104 is able to decide whether or not the user's hand 2a is included in the input image by comparing the input image to the template image through matching processing. The control device 104 makes an affirmative decision in step S20 upon judging that the user's hand 2a has been captured in the input image, and in this case, the operation proceeds to step S30. However, the control device 104 makes a negative decision in step S20 upon judging that the user's hand 2a has not been captured in the input image, and in this case, the operation proceeds to step S80.

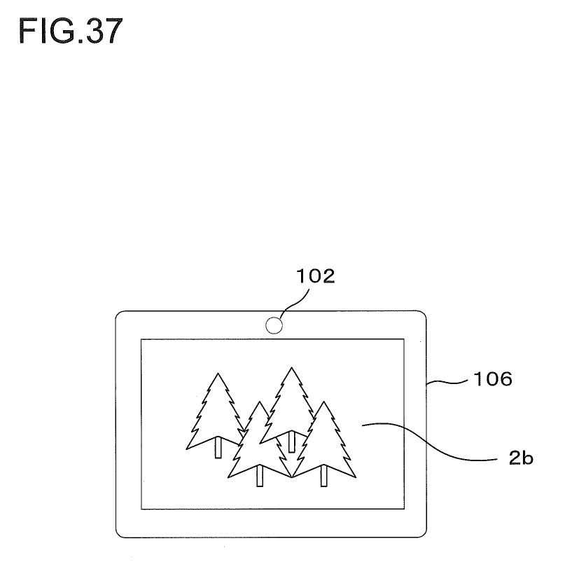

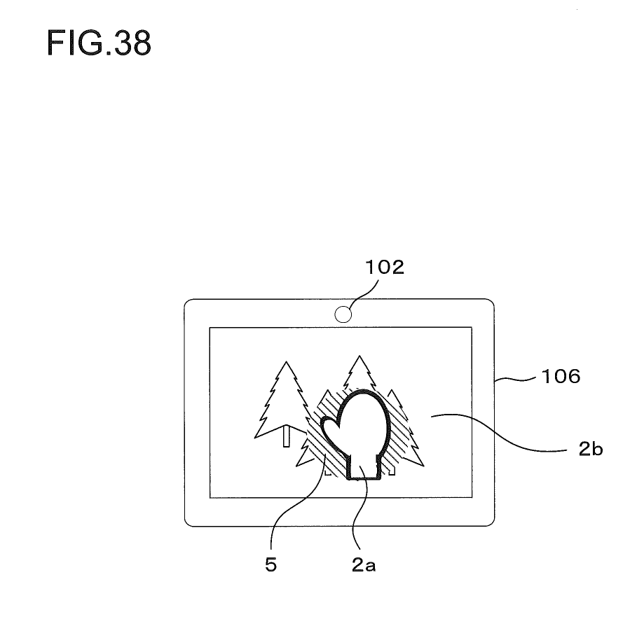

In step S30, to which they operation proceeds after deciding in step S20 that the user's hand 2a has been detected, the control device 104 switches to an alternative display mode for the image contained in an area surrounding the image area blocked by the user's hand 2a on the screen of the monitor 106 to the viewer's eye. FIG. 37 shows the monitor 106 at which the image 2b is displayed as a reproduced image. FIG. 38 illustrates how the user's hand 2a, held in front of the monitor 106 currently displaying the reproduced image 2b, may look.

The control device 104 executes display control so as to, for instance, lower the display luminance of an area 5 around an image area blocked by the hand 2a on the screen of the monitor 106 to the viewer's eye, relative to the display luminance set for the remaining image area other than the surrounding area 5. By switching to an alternative display mode in this manner, a visual effect whereby the user is left with an impression that the surrounding area 5 is separated from the remaining area is achieved.

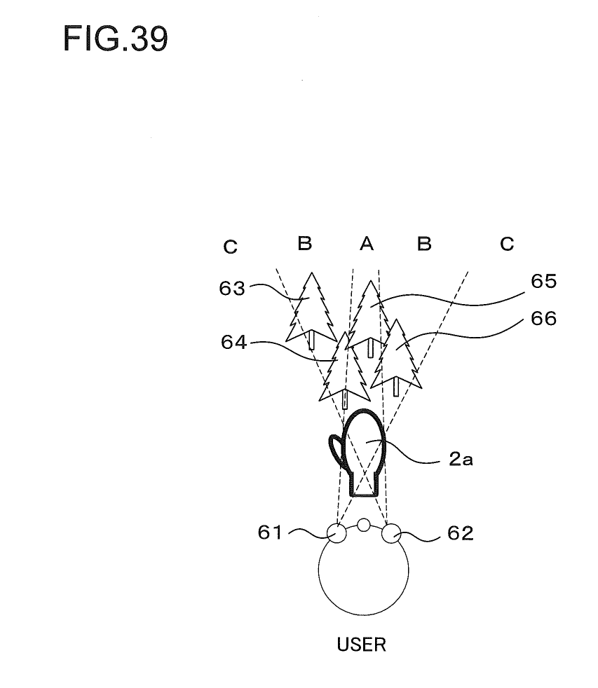

FIG. 39 illustrates the surrounding area 5. The user observes objects 63 to 66 in the viewing target image with his left and right eyes 61 and 62, as shown in FIG. 39. The user's hand 2a, held in front of the monitor, partially blocks the user's view of the objects 63 to 66. The letter A indicates an area of the image that becomes completely blocked from the user's view. The letter B indicates an area where the optimal parallax cannot be achieved with at least either the left eye 61 or the right eye 62 in the shadow of the hand 2a. The letter C indicates an area where the optimal parallax is achieved even when the hand 2a is held in front of the monitor.

The surrounding area 5 shown in FIG. 38 corresponds to the areas indicated by the letter B in FIG. 39. Over the areas indicated by the letters B and A, the user cannot view the left-side image and the right-side image separately from each other. For this reason, the user, viewing the surrounding area 5 on the display screen of the monitor 106, experiences some visual discomfort since he cannot view the image with a stereoscopic effect. However, such a sense of disruption, attributable to the fact that he can no longer view the particular image area with a stereoscopic effect, can be lessened by creating a visual impression of the surrounding area 5 being cut off from the remaining area for the user.

In the storage medium 105, information indicating a specific area bound to be blocked by the user's hand 2a to the viewer's eye on the display screen of the monitor 106 in relation to the distance from the camera 102 to the user's hand 2a and the position of the user's hand 2a assumed in the image plane of the photographic image captured with the camera 102, and information indicating the coordinates and the range of an area, assumed on the display screen of the monitor 106, for which the display mode should be switched, are stored in advance. The control device 104 reads out the information from the storage medium 105, identifies the range (corresponds to the surrounding area 5) for which the alternative display mode is to be switched to the image captured with the camera 102, as indicated by the information thus read, and then executes display control for the monitor 106 accordingly.

It is to be noted that the color saturation of the image in the surrounding area 5, displayed in the alternative display mode, may be lowered relative to the color saturation of the image in the remaining area or the contrast of the image in the surrounding area 5 may be lowered relative to the contrast of the image in the remaining area, instead of lowering the display luminance of the image in the surrounding area 5 relative to the display luminance of the image in the remaining area. In addition, different types of display control, such as those listed above, may be executed in combination.

Subsequently, the operation proceeds to step S40, in which the control device 104 makes a decision as to whether or not the position of the user's hand 2a has changed within the image, i.e., whether or not a movement of the user's hand 2a has been detected, by monitoring for any change in the position of the hand 2a occurring from one set of image data to another set of image data among sets of image data input in time series from the camera 102. The control device 104 makes an affirmative decision in step S40 upon detecting a movement of the hand 2a and proceeds to step S50. The control device 104 makes a negative decision in step S40 if no movement of the hand 2a has been detected. In this case, the operation proceeds to step S60.

In step S50, the control device 104 manipulates the reproduced image 2b currently on display in correspondence to the movement of the user's hand 2a having been detected in step S40. Upon detecting that the user's hand 2a has moved sideways, the control device 104 switches the reproduced image 2b to another image in correspondence to the movement of the user's hand 2a, as illustrated in FIG. 35. For instance, upon detecting that the user's hand 2a has moved to the left, the control device 104 slides the reproduced image 2b to the left and displays the image immediately following the image 2b by sliding the following image to the left. If, on the other hand, the control device 104 detects that the user's hand 2a has moved to the right, it slides the reproduced image 2b to the right and displays the image immediately preceding the image 2b by sliding the preceding image to the right. Thus, the user is able to issue a display image switching instruction in an intuitive manner with a simple gesture of his hand.

In step S60, the control device 104 makes a decision based upon the image data input thereto from the camera 102 as to whether or not the user's hand 2a has been captured in an input image. The control device 104 makes an affirmative decision in step S60 upon judging that the user's hand 2a continuous to be included in the photographic image, and in this case, the operation returns to step S40 to repeatedly execute the processing described above. However, the control device 104 makes a negative decision in step S60 upon judging that the user's hand 2a is no longer included in the photographic image and in this case, the operation proceeds to step S70.

In step S70, the control device 104 executes display control so as to switch back from the alternative display mode having been sustained for the image portion since step S30, to the initial display mode. As a result, the operation exits the alternative display mode having been sustained for the surrounding area 5 around the image area blocked by the user's hand 2a to the viewer's eye.

Subsequently, the operation proceeds to step S80, in which the control device 104 makes a decision as to whether or not the user has issued an instruction for ending the image reproduction. The control device 104, having received an operation signal indicating a reproduction end instruction from the operation member 101, makes an affirmative decision in step S80 and ends the processing shown in FIG. 36. If an operation signal indicating a reproduction end instruction has not been received, the control device 104 makes a negative decision in step S80 and the operation returns to step S20.

The following advantages are achieved through the twelfth embodiment described above.

(1) The digital photo frame 100 comprises a monitor 106 at which at least two images (parallax images), manifesting different parallaxes in correspondence to a plurality of viewpoints, are displayed, a camera 102 used to detect the hand 2a held in front of the monitor 106, a control device 104 that identifies, based upon detection results provided from the camera 102, a specific area of the display screen at the monitor 106, which is blocked by the hand 2a to the viewer's eye, and a control device 104 that executes display control so as to display the portion of the image displayed at the monitor 106, which is contained in a surrounding area 5 around the identified area by switching to an alternative display mode different from the display mode for the image in the remaining area. As a result, the sense of visual disruption that the user is bound to experience due to the image of his hand 2a on the display screen used for multi-viewpoint display can be lessened. More specifically, while the user, viewing an image on the display screen of the monitor 106 will tend to experience a sense of disruption if the image viewed over the surrounding area 5 no longer maintains a stereoscopic appearance, such a sense of disruption attributable to the loss of stereoscopic effect can be lessened by giving a visual impression to the user that the surrounding area 5 is cut off from the remaining area.

(2) The control device 104 in the digital photo frame 100 described in (1) above switches to the alternative display mode by altering at least one of; the luminance, the color and the contrast of the display image. Thus, an optimal visual effect whereby the user is left with an impression of the surrounding area 5 being cut off from the remaining area can be achieved.

(3) The camera 102 in the digital photo frame 100 described in (1) and (2) above detects the hand 2a based upon image signals output from the image sensor. Thus, the presence of the hand 2a held in front of the monitor 106 can be reliably detected.

(4) The digital photo frame 100 described in (1) through (3) above further includes a control device 104 functioning as an interface that takes in an operation corresponding to the movement of the hand 2a detected via the camera 102. Thus, the sense of disruption attributable to the loss of stereoscopic effect can be lessened in conjunction with the configuration that includes an interface taking in gesture operation signals at an apparatus that provides a multi-viewpoint display.

(5) The camera 102 at the digital photo frame 100 described in (1) through (4) above detects a human hand 2a, making it possible to lessen the sense of disruption attributable to the loss of stereoscopic effect caused by the hand 2a held in front of the monitor 106.

### Thirteenth Embodiment

The thirteenth embodiment is distinguishable from the twelfth embodiment in that an alternative display mode is adopted for the surrounding area 5 around the area blocked by the hand 2a on the screen of the monitor 106 to the viewer's eye by assuming a greater difference between the parallaxes of the parallax images for the surrounding area 5 compared to the remaining area. The surrounding area 5 displayed in such an alternative display mode is bound to give an impression of being cut off from the remaining area to the user.

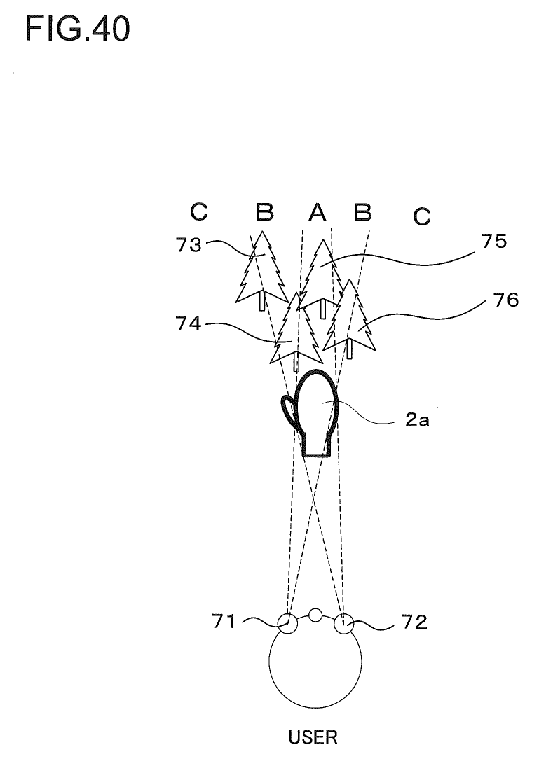

FIG. 40 illustrates the surrounding area 5. The user observes objects 73 to 76 in the viewing target image with his left and right eyes 71 and 72, as shown in FIG. 40. The user's hand 2a, held in front of the monitor, partially blocks the user's view of the objects 73 to 76. The letter A indicates an area of the image that becomes completely blocked from the user's view. The letter B indicates an area where the optimal parallax cannot be achieved with at least either the left eye 71 or the right eye 72 in the shadow of the hand 2a. The letter C indicates an area where the optimal parallax is achieved even when the hand 2a is held in front of the monitor. The surrounding area 5 corresponds to the areas indicated by the letter B.

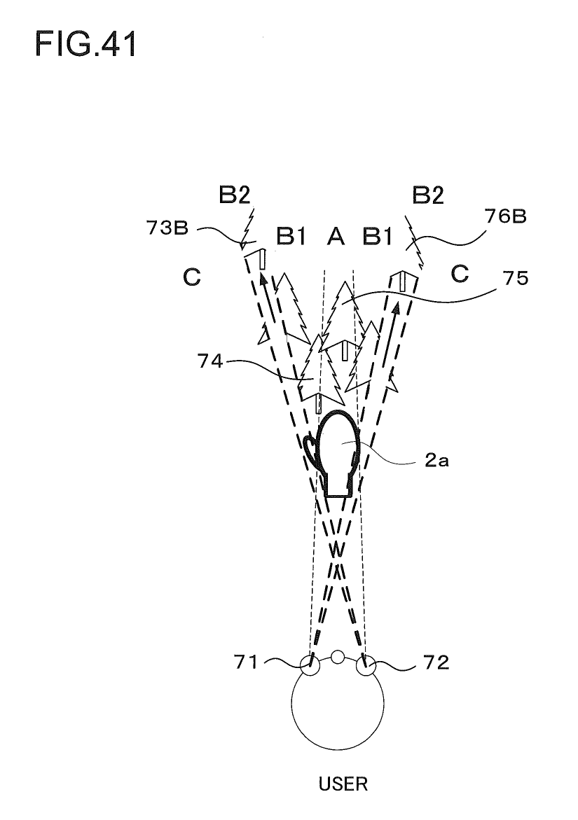

As does the control device 104 achieved in the twelfth embodiment, the control device 104 in the thirteenth embodiment first identifies the range that corresponds to the surrounding area 5 to be displayed in the alternative display mode based upon an image captured with the camera 102 and then executes display control for the monitor 106. FIG. 41 illustrates how the parallaxes may be altered. The control device 104 executes control so as to make the image portions contained in areas B2 of the areas B, present toward the borders with the areas C, appear to be further away by assuming different parallaxes for the parallax images displayed over these areas at the monitor 106 from the parallaxes of the parallax images displayed in the remaining area. In the example presented in FIG. 41, parallaxes are achieved so that a portion 73B of the object 73 and a portion 76B of the object 76 appear to be present further away. The portion 73B of the object 73 and the portion 76B of the object 76 each correspond to an area B2.

Through the thirteenth embodiment, in which some objects are made to appear to be further away, as described above, the sense of disruption experienced by the user attributable to the loss of stereoscopic perception can be lessened, since the user is left with an impression of the surrounding area 5 being cut off from the remaining area.

Advantages similar to those of the twelfth embodiment is achieved through the thirteenth embodiment described above. Furthermore, since the control device 104 in the digital photo frame 100, which switches to the alternative display mode by changing the parallaxes assumed for the display image, is able to create an optimal visual impression of the surrounding area 5 being cut off from the remaining area for the user.

(Variation 1)

An infrared light source may be disposed so as to illuminate the user facing the monitor 106. In such a case, the camera 102 captures an image of the user's hand 2a illuminated by the infrared light source. In the infrared image captured with the camera 102, the brightness of the area corresponding to the hand 2a is bound to be high and thus, the detection processing executed to detect the hand 2a in the infrared image will be facilitated.

(Variation 2)

While the user's hand 2a is detected via the camera 102 in the embodiments described above, the user's hand may instead be detected through a non-contact electrostatic detection method. As a further alternative, the user's hand may be detected via a distance sensor used in conjunction with a game console.

(Variation 3)

In the description provided above, the user holds a single hand 2a in front of the monitor 106. However, the present invention is not limited to this example and the user may be allowed to hold both hands in front of the monitor 106. In such a case, the control device 104 should individually identify a plurality of areas, each blocked by either the left hand or the right hand on the display screen of the monitor 106 to the viewer's eye, based upon an image captured with the camera 102 and should execute display control so as to display the images in a plurality of corresponding surrounding areas in a display mode different from the display mode for the remaining area. Through variation 3, a visual impression can be created for the user holding both his hands in front of the monitor that the surrounding areas, each corresponding to a hand of the user, are cut off from the remaining area.

It is to be noted that while the fingers of a hand held in front of the monitor 106 are not spread apart in the description given above, the user may hold his hand in front of the monitor by spreading his fingers apart. In such a case, display control should be executed by setting a surrounding area in correspondence to each finger and displaying the individual surrounding area in a display mode different from the display mode assumed for the remaining area.

(Variation 4)

Under the display control executed in the embodiment described earlier, the surrounding area blocked by the hand 2a to the viewer's eye is displayed by assuming a uniform display mode different from that of the remaining area. Instead, the display mode may be controlled so as to gradually alter the display appearance over the boundary between the surrounding area 5 and the remaining area to allow the surrounding area 5 to take on the appearance of becoming gradually blended into the remaining area.

(Variation 5)

While the image display apparatus according to the present invention is embodied as a digital photo frame in the description provided above, the present invention is not limited to this example and it may instead be adopted equally effectively in a digital camera, a portable telephone, a television set or the like equipped with a monitor 106 and a camera 102.

The embodiments are examples only and the present invention is not limited in any way whatsoever to the structural particulars of the embodiments described above. In addition, an embodiment may be adopted in combination with any of the variations.

Obviously, numerous modifications and variations of the present invention are possible in light of the above teachings. It is therefore to be understood that within the scope of the appended claims, the invention may be practiced otherwise than as specifically described herein.

What is claimed is:

1. An image display apparatus, comprising:
a detection unit that detects a target object; and
a display control unit that adjusts an image display method through which an image is displayed, so as to alter the image as visually perceived along a direction of visually perceived depth when the detection unit detects the target object.

2. The image display apparatus according to claim 1, wherein:
the display control unit alters the image continuously.

3. The image display apparatus according to claim 1, further comprising:
a movement detection unit that detects movement of the target object; and
an operation unit that manipulates the image in correspondence to the movement of the target object when the movement detection unit detects movement of the target object.

4. The image display apparatus according to claim 1, wherein:
the detection unit detects a position assumed by the target object.

5. The image display apparatus according to claim 1, wherein:
the display control unit alters the image along the direction of visually perceived depth by adding an image shadow effect.

6. The image display apparatus according to claim 1, wherein:
the display control unit alters the image along the direction of visually perceived depth by rendering the image so as to appear to sink into a perspective effect in a background area set around the image.

7. The image display apparatus according to claim 1, wherein:
the display control unit switches to a first method whereby the image is altered along the direction of visually perceived depth by adding an image shadow effect or to a second method whereby the image is altered along the direction of visually perceived depth by rendering the image to appear to sink into a perspective effect in a background area set around the image.

8. The image display apparatus according to claim 7, wherein:
the display control unit switches to the first method or to the second method in correspondence to the image or in correspondence to a direction in which the target object moves.

9. The image display apparatus according to claim 1, wherein:
the target object is a person's hand.

10. The image display apparatus according to claim 1, wherein:
the display control unit alters the image along the direction of visually perceived depth by altering at least one of; an image size, an image contrast, an image shape, an image smoothing, an image viewpoint position and an image color.

11. The image display apparatus according to claim 3, wherein:
the display control unit adjusts the image display method so as to alter a background area set around the image along the direction of visually perceived depth as well as the image when the detection unit detects the target object.

12. The image display apparatus according to claim 11, wherein:
the operation unit moves the image along the background area in correspondence to movement of the target object when the image and the background area are altered by the display control unit.

13. The image display apparatus according to claim 3, wherein:
the operation unit moves the image while altering a perceived distance to the image along the direction of visually perceived depth in correspondence to the movement of the target object.

14. The image display apparatus according to claim 13, wherein:
the operation unit alters the perceived distance to the image along the direction of visually perceived depth by altering at least one of; a size of a shadow added to an image, the image size, the image contrast, the image shape, an extent to which the image is smoothed, the image viewpoint position and the image color, in correspondence to the movement of the target object.

15. The image display apparatus according to claim 3, wherein:
the operation unit further alters the image along the direction of visually perceived depth by bringing up a reduced display of a plurality of images including the image if the movement detection unit detects movement of the target object toward the display unit when the image has been altered by the display control unit.

16. The image display apparatus according to claim 15, wherein:
the display control unit displays a cursor used to select an image in the reduced display; and
the operation unit moves the cursor in correspondence to an upward movement, a downward movement, a leftward movement or a rightward movement of the target object detected by the movement detection unit while the reduced display is up.

17. The image display apparatus according to claim 16, wherein:
the operation unit brings up the image selected with the cursor in an enlarged display if a movement of the target object moving further away from the display unit is detected by the movement detection unit while the reduced display is up.

18. The image display apparatus according to claim 3, wherein:
the operation unit switches the image to another image or moves a viewpoint taken for the image in correspondence to a rotation of the target object detected by the movement detection unit.

19. An image display apparatus comprising:
a detection unit that detects a target object; and
a display control unit that displays an image with a three-dimensional effect when the detection unit detects the target object.

20. The image display apparatus according to claim 19, wherein:
the detection unit detects a position assumed by the target object.

21. The image display apparatus according to claim 20, further comprising:
a movement detection unit that detects movement of the target object, wherein:
the display control unit alters the distance between the target object and the image along a perceived depthwise direction in correspondence to movement of the target object when the movement detection unit detects movement of the target object.

22. The image display apparatus according to claim 21, wherein:
the display control unit alters the image so that the distance between the target object and the image along a depthwise direction is visually perceived to be constant at all times.

23. The image display apparatus according to claim 20, wherein:
the display control unit displays the image with a three-dimensional effect so that the image appears to jump forward by shortening a visually perceived distance between the target object and the image along a depthwise direction.

24. The image display apparatus according to claim 23, wherein:
the display control unit renders the image so that the image appears to jump to a position close to the target object.

25. The image display apparatus according to claim 20, wherein:
the display control unit displays the image with a three-dimensional effect so that the image appears to sink inward by increasing a visually perceived distance between the target object and the image along a depthwise direction.

26. The image display apparatus according to claim 20, wherein:
the display control unit switches to a first method whereby a three-dimensional display effect is achieved for the image so that the image appears to jump forward by shortening a visually perceived distance between the target image and the image along a front-back direction or to a second method whereby a three-dimensional display effect is achieved for the image so that the image appears to sink inward by increasing the visually perceived distance between the target object and the image along the front-back direction.

27. The image display apparatus according to claim 26, wherein:
the display control unit switches to the first method or to the second method in correspondence to the image or in correspondence to a direction in which the target object moves.

28. The image display apparatus according to claim 19, wherein:
the target object is a person's hand.

29. The image display apparatus according to claim 19, wherein:
the display control unit displays the image with a three-dimensional effect by altering the shape of the image and also by rendering a visually perceived depth corresponding to the shape when the detection unit detects the target object.

30. The image display apparatus according to claim 21, wherein:
the display control unit moves the image while altering the perceived distance between the target object and the image along the depthwise direction in correspondence to the movement of the target object.

31. The image display apparatus according to claim 21, further comprising:
a processing execution unit that executes processing designated in correspondence to the image when the movement detection unit detects that the target object has moved toward a display unit until a distance between the target object and the display unit has become equal to or less than a predetermined value.

32. The image display apparatus according to claim 21, wherein:
the display control unit reduces a plurality of images including the image and bring up a three-dimensional display of the images when the movement detection unit detects a movement of the target object toward a display unit.

33. An image display apparatus comprising:
a display unit at which at least two display images manifesting parallaxes different from one another are each displayed toward a corresponding viewpoint among viewpoints taken for the plurality of images;
a detection unit that detects an object present in front of the display unit;
a specific area determining unit that determines, based upon detection results provided by the detection unit, a specific area of a display screen at the display unit that is blocked by the object when observed by a viewer; and
a display control unit that executes display control so as to display a portion of an image displayed at the display unit, which is contained in an area around the specific area having been determined, by adopting a display mode different from a display mode for a remaining area.

34. The image display apparatus according to claim 33, wherein:
the display control unit alters the display mode by altering at least one of; brightness, color and contrast of at least one display image.

35. The image display apparatus according to claim 33, wherein:
the display control unit alters the display mode by changing the parallax manifested in correspondence to at least one of the plurality of display images.

36. The image display apparatus according to claim 33, wherein:
the detection unit detects the object based upon an image signal output from an image sensor.

37. The image display apparatus according to claim 33, further comprising:
an operation control unit that takes in an operation corresponding to a movement of the object detected by the detection unit.

38. The image display apparatus according to claim 33, wherein:
the object is a person's hand.
